(19) United States
(12) Patent Application Publication
(10) Pub. No.: US 2008/0052647 A1
(43) Pub. Date: Feb. 28, 2008

(54) COMPUTER DEVELOPMENT APPARATUS

(76) Inventors: Tsutomu Yamada, Hitachinaka (JP); Tatsuya Maruyama, Hitachi (JP); Hisanori Nonaka, Naka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/835,521

(22) Filed: Aug. 8, 2007

(30) Foreign Application Priority Data
Aug. 23, 2006 (JP) 2006-226384

(51) Int. Cl. G06F 17/50

(52) U.S. Cl. 716/5

(57) ABSTRACT

A computer development apparatus includes hardware-parts where design data on hardware parts are caused to correspond to each other for each of information for identifying the hardware parts, software-parts where design data on software parts are caused to correspond to each other for each of information for identifying the software parts, relation for registering data for identifying a hardware part and a software part for each function of computer, the hardware part and the software part being necessary for implementing each function, constraint condition for specifying functions of a development-target computer, and extraction unit for identifying hardware part and software part by using the constraint condition and the relation, the hardware and software parts being necessary for implementing the functions included in the constraint condition, extracting, out of the hardware-parts and the software-parts, design data corresponding to the identified hardware part and software part, and outputting the extracted design data.

### BACKGROUND OF THE INVENTION

1. Field of the Invention

The present invention relates to technologies for developing a computer apparatus. More particularly, it relates to technologies for developing a computer apparatus in such a manner that hardware configuration elements and software configuration elements configuring the computer apparatus are selected from design resources.

2. Description of the Related Art

Technology on a scheme for developing a computer apparatus has been disclosed in JP-A-2005-234703. In JP-A-2005-234703, the disclosure has been made concerning the technology on a method, apparatuses, and programs for supporting development task at the time when, based on an electronic appliance whose development has been already finished, an electronic appliance similar thereto is developed. The electronic appliance whose development has been already finished includes a processing unit (MPU) and peripheral equipment. The processing unit executes firmware for controlling the peripheral equipment. Moreover, in JP-A-2005-234703, the disclosure has been also made regarding the following tasks: Selection of a component in the circuit configuration by selecting a function of the already-developed electronic appliance at the time when the electronic appliance similar thereto is developed, deletion or modification of pins of the MPU corresponding to the component, and a modification method for modifying machine-language program of the firmware.

By the way, in the development of a computer apparatus, in the case of an embedded computer apparatus in particular, the following case example is currently increasing in number: Namely, in addition to real-time control technology for the apparatus control, information communications technology is fully utilized for information sharing on networks. On account of this situation, in order to develop the embedded computer apparatus, it is becoming more and more required to provide both knowledge, i.e., not only knowledge about basic software (Operating System; OS) for the real-time control technology, but also knowledge about communications hardware and device driver (software) for the information communications. At worksite of the development, it is strongly desired to make use of technologies and operation methods which allow implementation of a good-quality design of both hardware and software of the computer apparatus, an enhancement in the development efficiency, and a reduction in burden imposed on the developer.

In JP-A-2005-234703, however, there exist the following problems: Namely, concretely, the technology disclosed in JP-A-2005-234703 is a one for performing partial deletion or modification of functions in the already-developed electronic appliance. This technology, however, is not a one for allowing necessary hardware and software corresponding thereto to be newly selected in accordance with a function that the developer desires. Also, in JP-A-2005-234703, the modification of the firmware for the already-developed electronic appliance is performed without using compiler. As a result, there is a need of newly developing an electronic appliance when the MPU or OS is modified. On account of this, the developer must perform designs about the necessary hardware and software again.

Incidentally, in general, a procedure of diverting design resources of an already-developed product is taken as a methodology for enhancing the development efficiency. In many cases, however, how to use the hardware and software resources or methods associated therewith cannot be clearly understood, unless the person in charge of the diversion is the developer himself or herself. Consequently, the diversion of the design resources is difficult to accomplish even within one and the same enterprise.

### SUMMARY OF THE INVENTION

The present invention has been devised in view of the above-described circumstances. Accordingly, an object of the present invention is to develop hardware and software of a computer apparatus with a high efficiency.

In order to solve the above-described problems, one aspect of the present invention is as follows: A computer development apparatus for holding design resource information and extracting, out of the design resource information, design data for implementing specified functions of a computer, the design resource information being a collection of computer design data, wherein the design resource information includes a hardware-parts database and a software-parts database, the hardware-parts database being a database for registering design data on hardware parts in a manner of being caused to correspond to each other for each of hardware-parts identification data for identifying the hardware parts, the software-parts database being a database for registering design data on software parts in a manner of being caused to correspond to each other for each of software-parts identification data for identifying the software parts.

Moreover, the computer development apparatus further includes a relation database for registering data for identifying a hardware part and a software part for each function of a computer, the hardware part and the software part being necessary for implementing each function, a constraint condition database for registering a constraint condition, the constraint condition including information for specifying functions of a development-target computer, and an extraction unit for identifying a hardware part and a software part for each function included in the constraint condition by using the constraint condition database and the relation database, the hardware part and the software part being necessary for implementing each function, extracting, out of the design resource information, design data corresponding to the identified hardware part and software part, and outputting the extracted design data.

The utilization of the present invention makes it possible to develop hardware and software of a computer apparatus with a high efficiency.

### BRIEF DESCRIPTION OF THE DRAWINGS

FIG. 1 is a functional block diagram for illustrating configuration of the computer development apparatus in a first embodiment of the present invention;

FIG. 2 is a diagram for illustrating an example of hardware configuration of the computer development apparatus in the first embodiment of the present invention;

FIG. 3 is a diagram for illustrating operation flow of an extraction unit 180 of the computer development apparatus in the first embodiment of the present invention;

FIG. 4 is a diagram for schematically illustrating data configuration of a hardware-parts DB 100 in the first embodiment of the present invention;

FIG. 5A and FIG. 5B are explanatory diagrams for explaining hardware parts in the first embodiment of the present invention;

FIG. 6 is a diagram for schematically illustrating data configuration of a software-parts DB 120 in the first embodiment of the present invention;

FIG. 7 is a diagram for schematically illustrating data configuration of a relation-parts DB 140 in the first embodiment of the present invention;

FIG. 8 is a diagram for schematically illustrating data configuration of a constraint condition DB 160 in the first embodiment of the present invention;

FIG. 9 is a diagram for illustrating detailed processing flow of the selection processing indicated at S510 in FIG. 3;

FIG. 10 is a diagram for illustrating detailed processing flow of the optimization processing indicated at S530 in FIG. 3;

FIG. 11 is a diagram for illustrating detailed processing flow of the output processing indicated at S550 in FIG. 3;

FIG. 12 is a diagram for illustrating an example of hardware design data 260 and software design data 280 outputted by the extraction unit 180 in the first embodiment of the present invention;

FIG. 13 is a functional block diagram for illustrating configuration of the computer development apparatus in a second embodiment of the present invention;

FIG. 14 is a diagram for illustrating an example of hardware configuration of the computer development apparatus 5 in the second embodiment of the present invention;

FIG. 15 is a diagram for schematically illustrating data configuration of a test-parts DB 320 in the second embodiment of the present invention;

FIG. 16 is a diagram for schematically illustrating data configuration of a relation-parts DB 340 in the second embodiment of the present invention;

FIG. 17 is a diagram for schematically illustrating data configuration of a constraint condition DB 400 in the computer development apparatus 5 in the second embodiment of the present invention;

FIG. 18 is a diagram for illustrating detailed processing flow of the additional output processing performed in the second embodiment of the present invention;

FIG. 19 is a diagram for schematically illustrating data configuration of test design data 380 outputted by an extraction unit 360 in the second embodiment of the present invention;

FIG. 20 is a functional block diagram for illustrating the computer development apparatus in a third embodiment of the present invention;

FIG. 21 is a diagram for illustrating an example of hardware configuration of the computer development apparatus in the third embodiment of the present invention;

FIG. 22 is a diagram for illustrating a configuration example of a constraint setting unit 300 in the third embodiment of the present invention; and

FIG. 23 is a diagram for illustrating an example of a constraint screen outputted at a terminal 4 in the third embodiment of the present invention.

### DESCRIPTION OF THE INVENTION

Hereinafter, referring to drawings, the explanation will be given below concerning embodiments of the present invention. Incidentally, the present embodiment relates to the configuration of a computer development apparatus for generating design data on a computer apparatus of a new configuration. Here, when developing hardware and software of the computer apparatus, generating the design data is performed by fully utilizing already-existing design data.

### 1ST EMBODIMENT

First, referring to the drawings, the explanation will be given below concerning the computer development apparatus in a first embodiment of the present invention.

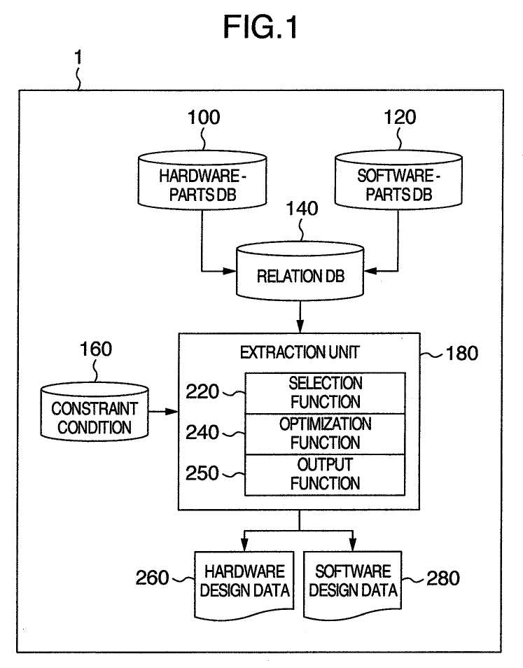

FIG. 1 is a functional block diagram for illustrating configuration of the computer development apparatus in the first embodiment of the present invention.

As illustrated in the drawing, the computer development apparatus 1 includes a hardware-parts DB 100, a software-parts DB 120, a relation DB 140, a constraint condition 160, and an extraction unit 180 for extracting design data. The extraction unit 180 includes three functions, i.e., a selection function 220, an optimization function 240, and an output function 250. These functions will be explained in detail later.

The hardware-parts DB 100 is a database for storing information on hardware parts necessary for implementing predetermined functions of a computer.

The software-parts DB 120 is a database for storing information on software parts for controlling the hardware parts and the basic software (OS). The relation DB 140 is a database for making the hardware-parts DB 100 and the software-parts DB 120 related with each other. Incidentally, configuration of these databases will be explained in detail later.

The developer sets the constraint condition 160 into the computer development apparatus 1, thereby specifying a computer function needed for a development-target computer. The extraction unit 180 of the computer development apparatus 1 extracts a hardware part and a software part which are related with the computer function specified in the constraint condition 160, then converting the extracted hardware and software parts as required. Incidentally, the function description in the constraint condition 160 may be, e.g., either text format by text editor or document processing software, or binary data set by database software.

The extraction unit 180 outputs the respective extracted and converted results as hardware design data 260 and software design data 280. These processings will be explained in detail later.

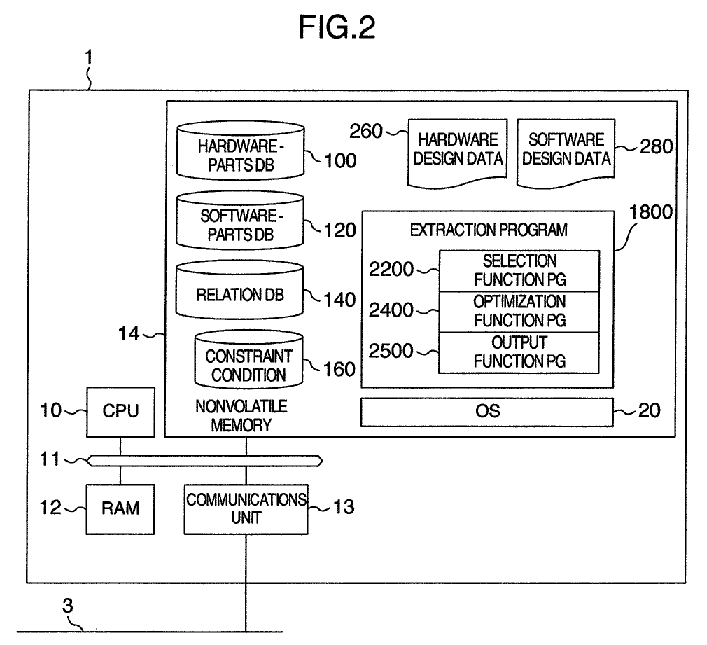

Next, referring to FIG. 2, the explanation will be given below regarding hardware configuration of the computer development apparatus 1.

FIG. 2 is a diagram for illustrating an example of the hardware configuration of the computer development apparatus 1 in the first embodiment of the present invention.

As illustrated in the drawing, the computer development apparatus 1 includes a CPU 10, an internal bus 11, a RAM (Random Access Memory) 12, a communications unit 13, and a nonvolatile memory 14. The CPU 10, the RAM 12, the communications unit 13, and the nonvolatile memory 14 exchange data with each other via the internal bus 11.

The nonvolatile memory 14 stores therein the hardware-parts DB 100, the software-parts DB 120, the relation DB 140, the constraint condition 160, the hardware design data 260, the software design data 280, an OS 20, and an extraction program 1800. The extraction program 1800 is a program for implementing the functions of the extraction unit 180 illustrated in FIG. 1. The extraction program 1800 includes a selection function program 2200 for implementing the selection function 220, an optimization function program 2400 for implementing the optimization function 240, and an output function program 2500 for implementing the output function 250. Incidentally, in the present embodiment, the nonvolatile memory 14 is not specifically limited. Namely, storage devices available as the nonvolatile memory 14 are, e.g., electrically erasable and writable EEPROM (Electrically Erasable Programmable Read-Only Memory), flash memory, or hard disc.

The CPU 10 reads respective types of information such as instructions and constants of the OS 20 and the software (such as the extraction program 1800) stored in the nonvolatile memory 14. Then, the CPU 10 stores these instructions and constants into the RAM 12 as required, and performs a read or write processing, then executing the software processing. The software processing executed by the CPU 10 allows the implementation of the functions of the extraction unit 180 illustrated in FIG. 1. Namely, the above-described functions of the extraction unit 180 are implemented by the CPU 10 in such a manner that the CPU 10 loads, onto the RAM 12, and executes the OS 20, the extraction program 1800, and the respective types of information stored in the nonvolatile memory 14.

The communications unit 13 performs a processing where data requested from the CPU 10 via the internal bus 11 is transmitted to a network 3, or a processing where a processing received from the network 3 is reported to the CPU 10. Incidentally, the present embodiment is not specifically limited by network technologies which utilize the network 3. As the network technologies which utilize the network 3, there exist Ethernet (trademark) and RS485, i.e., wired network technology, serial transmission technology by optical fibers or the like, or parallel transmission technology such as SCSI (Small Computer System Interface) and PCI (Peripheral Component Interconnect). Using an interrupt signal (not illustrated), the communications unit 13 notifies the CPU 10 of a change in its own state or occurrence of a processing request. The CPU 10 performs the execution of the above-described software and the interrupt processing from the communications unit 13, thereby allowing the implementation of the functions to be intended.

Subsequently, the explanation will be given below concerning outline of operation of the computer development apparatus 1 in the first embodiment of the present invention.

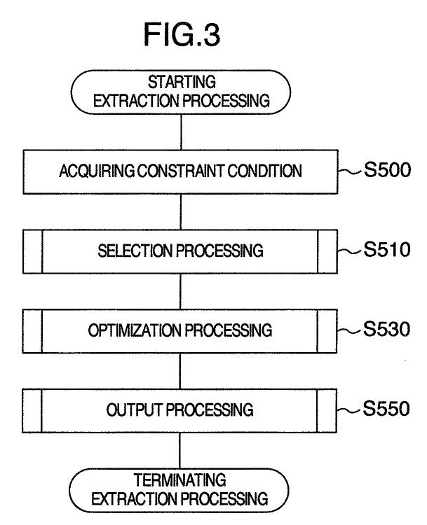

FIG. 3 is a diagram for illustrating operation flow of the extraction unit 180 of the computer development apparatus 1 in the first embodiment of the present invention. Incidentally, it is assumed that the constraint condition 160 is set in advance into the computer development apparatus 1 for performing processing steps which will be described hereinafter (it is assumed that the constraint condition 160 is stored into a predetermined area of the nonvolatile memory 14).

First, the extraction unit 180 acquires a function of a development-target computer from the constraint condition 160 (S500). The constraint condition 160 is data describing the development-target computer function given in advance in text format or binary format.

Next, the extraction unit 180 extracts hardware parts and software parts for implementing the development-target computer function specified by the constraint condition 160 (S510). Concretely, the extraction unit 180 extracts a corresponding record from the relation DB 140, using the selection function 220. In the record in the relation DB 140, an index to the hardware-parts DB 100 and an index to the software-parts DB 120 are described in a manner of being caused to correspond to the development-target computer function. The extraction unit 180 extracts hardware-parts data from the hardware-parts DB 100, using the index to the hardware-parts DB 100 registered in the extracted record. Also, the extraction unit 180 extracts software-parts data from the software-parts DB 120.

After that, using the optimization function 240, the extraction unit 180 deletes a redundant hardware part and software part, and simultaneously modifies a parameter of each part (S530). As an example of the parameter to be modified, there can be mentioned values such as memory capacity or clock cycle of the processor corresponding to the development-target computer function.

Moreover, using the output function 250, the extraction unit 180 outputs, of the optimized processing results, the design data on the hardware parts as the hardware design data 260 and the design data on the software parts as the software design data 280, respectively (S550), thereby terminating the processing. Incidentally, the hardware design data 260 and the software design data 280 may be stored into the nonvolatile memory 14, or may be transferred to another computer apparatus (not illustrated) via the communications unit 13.

By setting the configuration as described above, from the constraint condition 160 corresponding to the development-target computer apparatus, it becomes possible to acquire the hardware design data 260 and the software design data 280 which are related with the constraint condition 160. The developer can design hardware of the development-target computer apparatus from the acquired hardware design data 260. After that, the developer can obtain the desired computer apparatus by implementing the OS and the device driver, which are included in the acquired software design data 280, into the designed hardware of the development-target computer apparatus.

Next, the detailed explanation will be given below concerning each configuration element and processing in the first embodiment of the present invention.

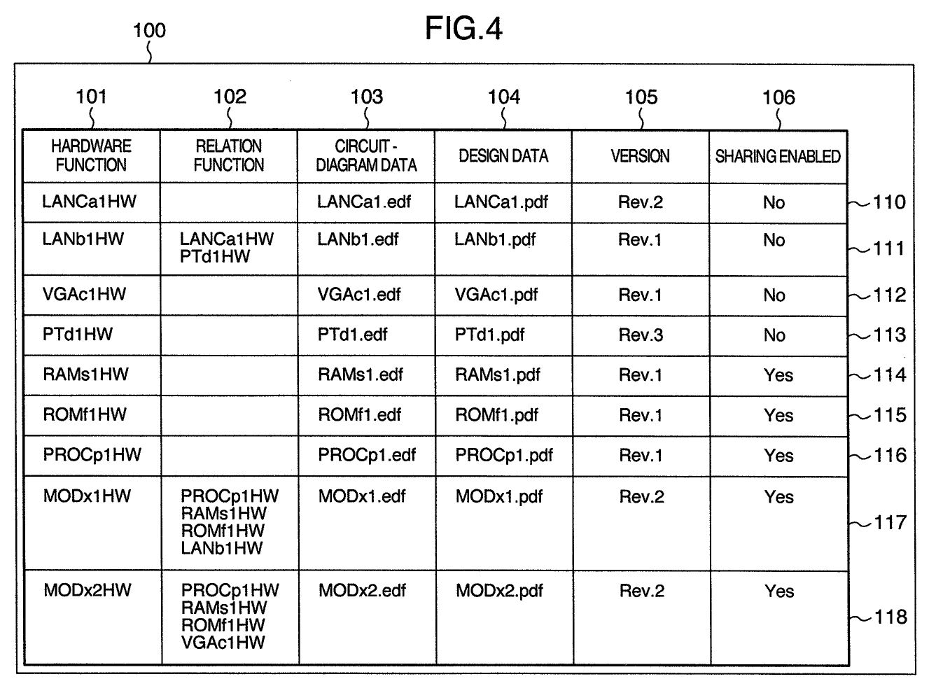

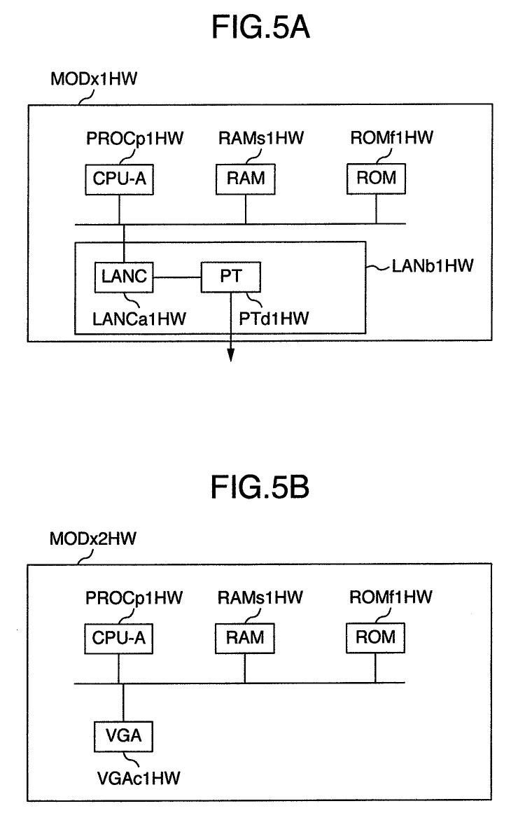

First, referring to FIG. 4, FIG. 5A, and FIG. 5B, the explanation will be given below regarding data configuration of the hardware-parts DB 100 in the present embodiment.

FIG. 4 is a diagram for schematically illustrating the data configuration of the hardware-parts DB 100 in the first embodiment of the present invention. FIG. 5A and FIG. 5B are diagrams for exemplifying circuit configurations of the hardware parts in the first embodiment of the present invention. Incidentally, the hardware-parts DB 100 illustrated in FIG. 4 indicates an example of including hardware-parts data on hardware parts of the circuit configurations illustrated in FIG. 5A and FIG. 5B.

Now, as illustrated in FIG. 4, one record of the hardware-parts DB 100 is constituted by a field 101 for registering data indicating hardware function, a field 102 for registering data indicating relation function, a field 103 for registering circuit-diagram data, a field 104 for registering design data, a field 105 for registering data indicating version, and a field 106 for registering a flag (sharing-enabled flag) indicating whether sharing is enabled or disabled.

Here, the data indicating the hardware function, which is registered into the field 101, is an index on the hardware part (i.e., identification information for identifying the hardware part).

The data indicating the relation function, which is registered into the field 102, is data related with the hardware function registered in the corresponding field 101 (or data indicating a hardware function included in the hardware function). For example, the data indicating the relation function is data indicating parts which configure the hardware function registered in the corresponding field 101.

The circuit-diagram data, which is registered into the field 103, is data indicating information for wiring the hardware part, or internal wiring information on the hardware part. As a concrete example of the circuit-diagram data, there can be mentioned data such as pin location data on the hardware part or EDIF (Electronic Design Interchange Format) data.

The design data, which is registered into the field 104, is data indicating information which is necessary when making the design using the hardware part. Data appropriate for the design data to be registered into the field 104 are, e.g., hardware manual, electrical specification, access timing specification, clock cycle, memory capacity, explanatory note, and usage method. Although, in the illustrated example, these pieces of design data are indicated in a summarized manner as document files of the file extension “pdf”, these pieces of design data may also be registered into the hardware-parts DB 100 as independent elements individually as required.

The data indicating the version, which is registered into the field 105, is data used when managing the hardware function stored in the corresponding field 101, and represents history of the hardware function.

The sharing-enabled flag, which is registered into the field 106, is a flag indicating whether or not the hardware part is a one which is sharing-enabled over a plurality of configurations. For example, in the case of the memory and the CPU, one and the same hardware part is available in the manner of being shared over a plurality of configurations as long as its usage amount or performance falls within an assumed range. On account of this, it is preferable to set the flag indicating the sharing-enabled property. On the other hand, in the case of a communications-specific part and input/output control part where a certain constant function is expected to be implemented by the one part, such as LAN (Local Area Network) controller and screen output function, the flag indicating the sharing-disabled property is set.

In the illustrated example, information on “LANCa1HW” is registered in the record 110 of the hardware-parts DB 100. In the record 110, concretely, “LANCa1HW” is registered in the field 101. No data is registered in the field 102. This shows that “LANCa1HW” has no relation function. Also, EDIF data (LANCa1.edf file) indicating the circuit diagram of “LANCa1HW” is registered in the field 103. The design data on “LANCa1HW” (e.g., manual LANCa1.pdf file) is registered in the field 104. Data (Rev. 2 (revision 2)) indicating that the version of “LANCa1HW” is 2 is registered in the field 105. The flag (“No”) indicating the sharing-disabled property is registered in the field 106.

Also, hardware-parts information which includes a single part as is the case with the record 110 is registered in records 112 to 116. Incidentally, data on a screen-output controlling hardware part “VGAc1HW” is registered in the record 112.

Information on “LANb1HW”, i.e., a hardware part including a plurality of parts, is registered in the record 111. Data indicating the plurality of parts are registered in the field 102 of the record 111. Concretely, the data registered in the field 102 of the record 111 shows that “LANb1HW” for providing the LAN function includes “LANCa1HW”, i.e., the LAN controller, and “PTd1HW”, i.e., a pulse transformer. Circuit-diagram data registered in the field 103 of the record 111 is EDIF data (LANb1.edf file) indicating how these relation functions (i.e., the relation functions registered in the field 102) are configured. As the design data, “manual LANb1.pdf file” is registered in the field 104. Data (Rev. 1 (revision 1)) indicating that the version is 1 is registered in the field 105. Also, the flag (“No”) indicating the sharing-disabled property is registered in the field 106.

Also, the data on the hardware part illustrated in FIG. 5A is registered in a record 117, and the data on the hardware part illustrated in FIG. 5B is registered in a record 118.

Concretely, information on a computer module “MODx1HW” is registered in the record 117. In the record 117, plural pieces of data are registered in the field 102, which shows that the computer module “MODx1HW” includes a plurality of parts. Also, circuit configuration of the computer module “MODx1HW” can be confirmed by circuit data (MODx1.edf) registered in the field 103. Data (Rev. 2 (revision 2)) registered in the field 105 makes it possible to confirm that the version is 2. Also, the sharing-enabled flag in the field 106 is “Yes”, which makes it possible to confirm that the computer module “MODx1HW” is a sharing-enabled hardware part.

Information on a computer module “MODx2HW” is registered in the record 118. Incidentally, the computer module “MODx2HW” registered in the record 118 is the same as the computer module “MODx1HW” registered in the record 117 except that the circuit configuration of “MODx2HW” is partially different from that of “MODx1HW” (i.e., except that the LAN function and the screen output function are exchanged with each other).

Here, referring to FIG. 5A and FIG. 5B, the explanation will be given below concerning the hardware part registered in the record 117 and the hardware part registered in the record 118.

FIG. 5A illustrates the configuration of the computer module “MODx1HW” i.e., the hardware part registered in the record 117 of the hardware-parts DB 100 illustrated in FIG. 4. The computer module “MODx1HW” includes “PROCp1HW”, i.e., a CPU, “RAMs1HW”, i.e., a RAM, “ROMf1HW”, i.e., a ROM, and “LANb1HW”, i.e., the LAN function. Here, “LANb1HW”, i.e., the LAN function, further includes the LAN controller “LANCa1HW” and the pulse transformer “PTd1HW”.

FIG. 5B illustrates the configuration of the computer module “MODx2HW” i.e., the hardware part registered in the record 118 of the hardware-parts DB 100 illustrated in FIG. 4. The computer module “MODx2HW” includes “PROCp1HW”, i.e., the CPU, “RAMs1HW”, i.e., the RAM, “ROMf1HW”, i.e., the ROM, and “VGAc1HW”, i.e., the hardware part for providing the screen output function.

By configuring the hardware-parts DB 100 as described above, concerning the hardware parts related with the configuration elements of the computer, it becomes possible to know the relation among these elements, the circuit-diagram data, the design data, the version, and whether the part sharing is enabled or disabled.

Next, the explanation will be given below regarding data configuration of the software-parts DB 120 in the present embodiment.

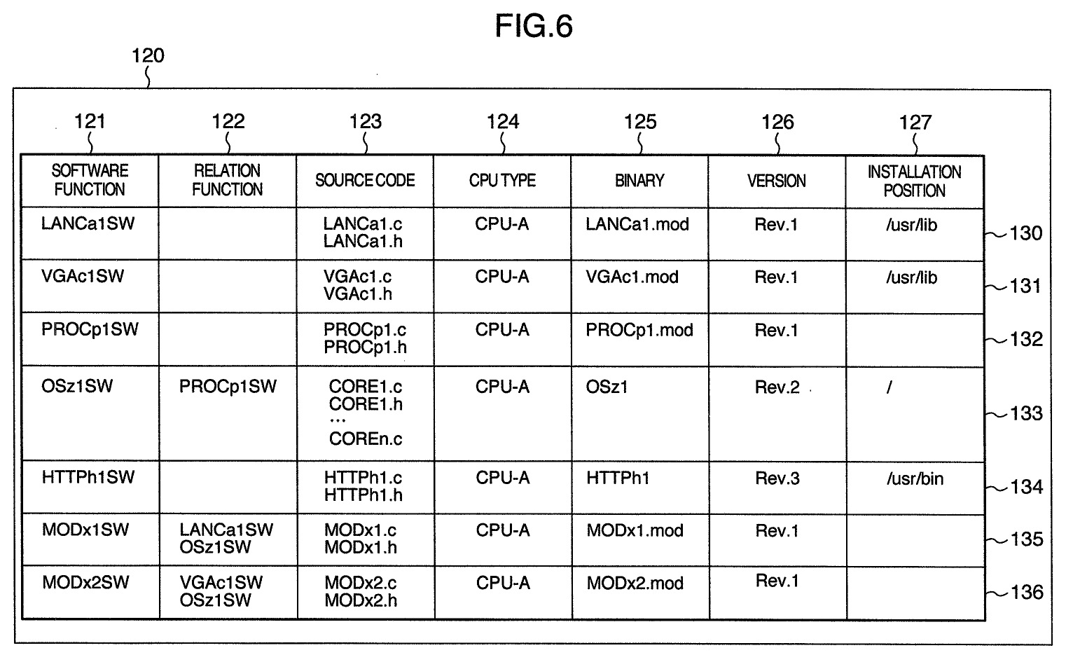

FIG. 6 is a diagram for schematically illustrating the data configuration of the software-parts DB 120 in the first embodiment of the present invention.

As illustrated in FIG. 6, one record of the software-parts DB 120 is constituted by a field 121 for registering data indicating software function, a field 122 for registering data indicating relation function, a field 123 for registering source code, a field 124 for registering data indicating CPU type, a field 125 for registering object code or binary, a field 126 for registering data indicating version, and a field 127 for registering data indicating installation position.

The software function, which is registered into the field 121, is an index on a software part (i.e., identification information for identifying the software part).

The data indicating the relation function, which is registered into the field 122, is data related with the software function registered in the corresponding field 121 (or data included in the software function). For example, the data indicating the relation function registered into the field 122 is partial functions which configure the software function.

The source code, which is registered into the field 123, is program code for describing the software function. Incidentally, the present invention is not limited by a specific describing language. In an illustrated example, the example of the source code which assumes C language (i.e., the file extension is “.c” or “.h”) is presented.

The CPU type, which is registered into the field 124, refers to processor architecture employed as the target when generating the binary by compiling the source code registered into the corresponding field 123.

The binary, which is registered into the field 125, is a program file name which includes the code generated by compiling the source code registered into the field 123, and whose format is interpretable by a CPU specified by the CPU type.

The data indicating the version, which is registered into the field 126, is data used when managing the software function registered in the corresponding field 121, and represents history of the software function.

The data indicating the installation position, which is registered into the field 127, is information indicating at which position the generated code (i.e., the binary) corresponding to the software function will be finally installed. For example, if the development-target computer is of an OS for managing a file system, it is preferable to indicate in which directory of the file system the corresponding software function will be stored. Also, in a case of an OS where all of drivers are statically linked to the kernel portion, the data indicating the installation position is unnecessary (namely, there is no need of registering the data into the field 127).

In the illustrated example of the software-parts DB 120, information on a software part “LANCa1SW” having software function designed for the LAN controller is registered in a record 130. Information on a software part “VGAc1SW” having software function designed for VGA chip is registered in a record 131. Information on a software part “PROCp1SW” having software function about the CPU is registered in a record 132.

Also, information on a software part “OSz1SW” having software function about the OS is registered in a record 133. Information on a software part “HTTPh1SW” having software function about Web servers is registered in a record 134. Information on a software part “MODx1SW” of software function about the computer module “MODx1HW” is registered in a record 135. Information on a software part “MODx2SW” of software function about the computer module “MODx2HW” is registered in a record 136.

Also, as the configuration elements of the software-parts DB 120, in addition to the above-described configuration elements, the following elements may also be included: A setting file to which reference is made when executing the binary (the binary registered into the field 125), a compile procedure file (such as makefile or script) used when compiling the source code, and the like.

In the illustrated example, the following data is presented: With respect to the software part “LANCa1SW” registered in the record 130 and controlling the LAN controller, the source code includes “LANCa1.c” and “LANCa1.h”, and the binary is “LANCa1.mod”. Moreover, the software part “LANCa1SW” is prepared in a processor whose CPU type is “CPU-A”, and the version is “revision 1”, and the installation position is “/usr/lib”.

With respect to the software part “OSz1SW” registered in the record 133 and having the OS function, the relation function is “PROCp1SW”, the source code includes a plurality of source files such as “CORE1.c” and “CORE1.h”, the CPU type is “CPU-A”, “OSz1” is prepared in the binary, the version is “Rev. 2 (revision 2)”, and the installation position is root “(/)”.

The information on the software part “MODx1SW”, which has the software function to be installed onto the computer module “MODx1HW” that is the hardware part, is registered in the record 135. Concretely, with respect to the software part “MODx1SW”, the following data is registered in the record 135: The descriptions on the LAN-controller driver and the OS (i.e., “LANCa1SW” and “OSz1SW”) are registered as the relation function, “MODx1.c” and “MODx1.h” are needed as the source code, the CPU type is “CPU-A”, the binary is “MODx1. mod”, and the version is “Rev. 1 (revision 1)”.

By configuring the software-parts DB 120 as described above, concerning the software parts related with the configuration elements of the computer, it becomes possible to know the relation among these elements, the source code, the binary corresponding to the CPU type, the version, and the installation position.

Next, the explanation will be given below regarding data configuration of the relation DB 140 in the present embodiment.

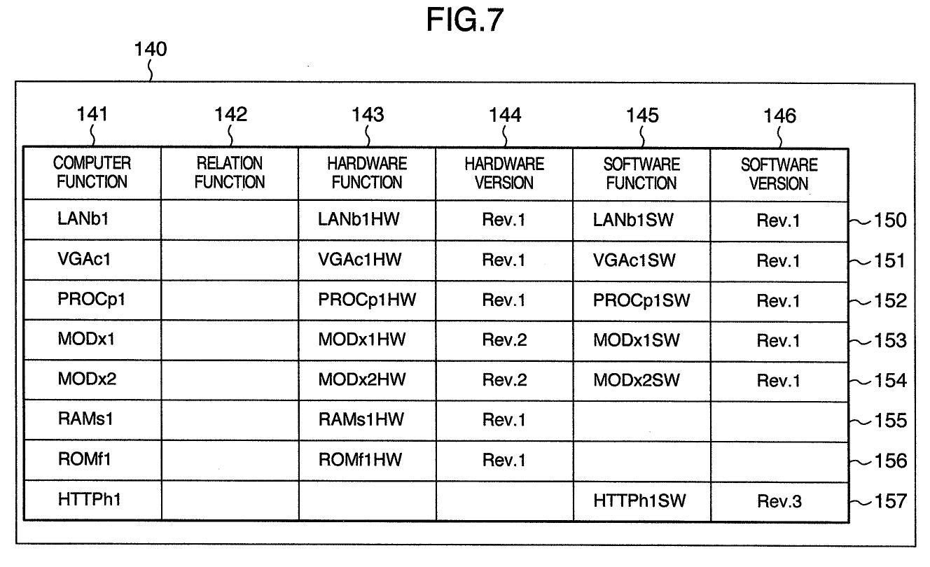

FIG. 7 is a diagram for schematically illustrating the data configuration of the relation DB 140 in the first embodiment of the present invention.

As illustrated in FIG. 7, one record of the relation DB 140 is constituted by a field 141 for registering data indicating function of a computer (computer function), a field 142 for registering data indicating relation function, a field 143 for registering data indicating hardware function, a field 144 for registering version (hardware version) indicating modification history of the hardware function, a field 145 for registering data indicating software function, and a field 146 for registering version (software version) indicating modification history of the software function. Namely, in one record, the relation function, the hardware function, the hardware version, the software function, and the software version are registered into the respective fields 142 to 146 in a manner of being caused to correspond to the computer function registered into the field 141.

The computer function, which is registered into the field 141, is name of function needed for a computer (i.e., data identifying function of a computer). In the present embodiment, addition or deletion of a function is performed with this described computer function used as its unit.

The relation function, which is registered into the field 142, is an element for specifying an already-existing computer function. The relation function is used when creating a new computer function.

The data indicating the hardware function, which is registered into the field 143, is basically the same data as the data registered into the field 101 of the records configuring the hardware-parts DB 100 illustrated in FIG. 4, i.e., identification information for identifying hardware parts. Also, the hardware version, which is registered into the field 144, is basically the same data as the data registered into the field 105 of the records configuring the hardware-parts DB 100 illustrated in FIG. 4.

The data indicating the software function, which is registered into the field 145, is basically the same data as the data registered into the field 121 of the records configuring the software-parts DB 120 illustrated in FIG. 6, i.e., identification information for identifying software parts. Also, the software version, which is registered into the field 146, is basically the same data as the data registered into the field 126 of the records configuring the software-parts DB 120 illustrated in FIG. 6.

In the example in FIG. 7, the data on the computer function are registered into records 150 to 157. In the illustrated records, there exist the records (e.g., records 150 to 154) where the hardware function and the software version are registered in pair, the records (e.g., records 155 and 156) where only the hardware function is registered, and the record (e.g., record 157) where only the software function is registered.

For example, in the record 153, both the hardware function “MODx1HW” and the software function “MODx1SW” are registered with respect to the computer module. Also, for example, in the record 155, only the hardware function “RAMs1HW” is registered with respect to the RAM function. In the record 157, only the software function “HTTPh1SW” is registered with respect to the Web server function.

Incidentally, in the present embodiment, it is effective enough to register only the configuration elements which are necessary for the relation DB 140. Also, even when the combinations of the hardware function registered into the field 143 and the software function registered into the field 145 are the same, if the respective versions are different, the hardware function and the software function may be managed using different records.

By configuring the relation DB 140 as described above, it becomes possible to know the relation between the hardware function and the software function corresponding to the computer function.

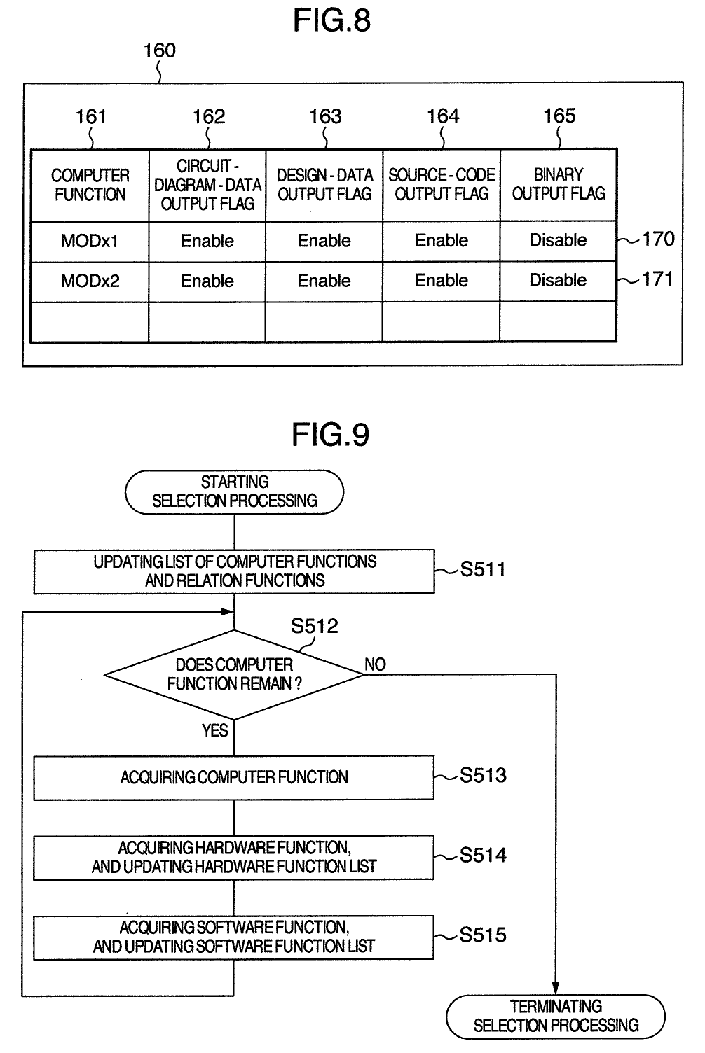

Subsequently, referring to FIG. 8, the explanation will be given below concerning the constraint condition 160 in the present embodiment.

FIG. 8 is a diagram for schematically illustrating data configuration of the constraint condition 160 in the first embodiment of the present invention. Incidentally, the constraint condition 160 is the data set by the user.

As illustrated in FIG. 8, one record of the constraint condition 160 is constituted by a field 161 for registering a computer function of a development-target computer, a field 162 for registering a flag (circuit-diagram-data output flag) for specifying whether or not to output the circuit-diagram data, a field 163 for registering a flag (design-data output flag) for specifying whether or not to output the design data, a field 164 for registering a flag (source-code output flag) for specifying whether or not to output the source code, and a field 165 for registering a flag (binary output flag) for specifying whether or not to output the binary. For example, in a record 170, the flags instruct the following constraint condition: With respect to the computer function “MODx1”, only the binary is not outputted (described as being “Disable”), and all the others are outputted (described as being “Enable”).

Subsequently, the detailed explanation will be given below concerning the operation flow of the extraction unit 180 explained in FIG. 3 presented earlier.

First, the detailed explanation will be given below regarding the selection processing indicated at S510 in FIG. 3.

FIG. 9 is a diagram for illustrating detailed processing flow of the selection processing indicated at S510 in FIG. 3. Here, the selection processing at S510 is the following processing: Namely, using the selection function 220, the extraction unit 180 (refer to FIG. 1) selects hardware functions and software functions which are related with computer functions specified in the constraint condition 160.

Incidentally, it is assumed that the extraction unit 180 holds a computer function list (not illustrated), a hardware function list (not illustrated), and a software function list (not illustrated) (these lists are stored into, e.g., a predetermined area of the RAM 12). Moreover, before entering the present processing flow, the extraction unit 180 initializes the held computer function list, hardware function list, and software function list into empty states. Incidentally, all the operations illustrated in FIG. 9 are performed by the selection function 220 of the extraction unit 180.

First, the extraction unit 180 extracts all of the computer functions specified in the constraint condition 160, and all of relation functions related with the respective computer functions. Then, the extraction unit 180 lists the extracted computer functions and the extracted relation functions, thereby creating the computer function list (S511). At the time of creating the computer function list, the extraction unit 180 includes, into the computer function list, the circuit-diagram-data output flag, the design-data output flag, the source-code output flag, and the binary output flag as well which are specified in the constraint condition 160.

Next, the extraction unit 180 sequentially performs processings at S512 to S515 to the computer functions listed in the created computer function list. Moreover, when the extraction unit 180 has executed the processings at S512 to S515 to all of the listed computer functions, the extraction unit 180 terminates the selection processing.

Concretely, the extraction unit 180 makes reference to the computer function list created at S511, and (e.g., by making reference to the computer function list sequentially from the above), confirms whether or not there exists at least one list element (S512). Moreover, if there remains no list element, the extraction unit 180 terminates the selection processing. On the other hand, if there remains at least one list element, the extraction unit 180 transitions to the processing at S513.

At S513, the extraction unit 180 extracts one piece of computer-function indicating data from the computer function list created at S511. Then, by making access to the relation DB 140 (refer to FIG. 7), the extraction unit 180 retrieves, from the records registered in the relation DB 140, a record in which the extracted computer-function indicating data is registered.

Next, the extraction unit 180 extracts hardware-function indicating data (i.e., the data registered in the field 143 in FIG. 7) from the record retrieved at S513, then adding (registering) the extracted hardware-function indicating data into the hardware function list (S514). At the time of adding the extracted data into the hardware function list, with respect to the computer function, the extraction unit 180 similarly adds, into the hardware function list, the circuit-diagram-data output flag (i.e., the data registered in the field 162 in FIG. 8) and the design-data output flag (i.e., the data registered in the field 163 in FIG. 8) as well in the constraint condition 160.

Next, the extraction unit 180 extracts software-function indicating data (i.e., the data registered in the field 145 in FIG. 7) from the record retrieved at S513, then adding (registering) the extracted software-function indicating data into the software function list (S515). Incidentally, at the present step as well, as is the case with S514, with respect to the computer function, the extraction unit 180 similarly adds, into the software function list, the source-code output flag (i.e., the data registered in the field 164 in FIG. 8) and the binary output flag (i.e., the data registered in the field 165 in FIG. 8) as well in the constraint condition 160. After that, the extraction unit 180 repeats the processing at S512 again.

The above-described processings allow the selection function 220 of the extraction unit 180 to list the hardware functions and the software functions which are necessary for implementing the desired computer functions, in correspondence with the computer functions specified in the constraint condition 160.

Next, the detailed explanation will be given below concerning the optimization processing indicated at S530 in FIG. 3.

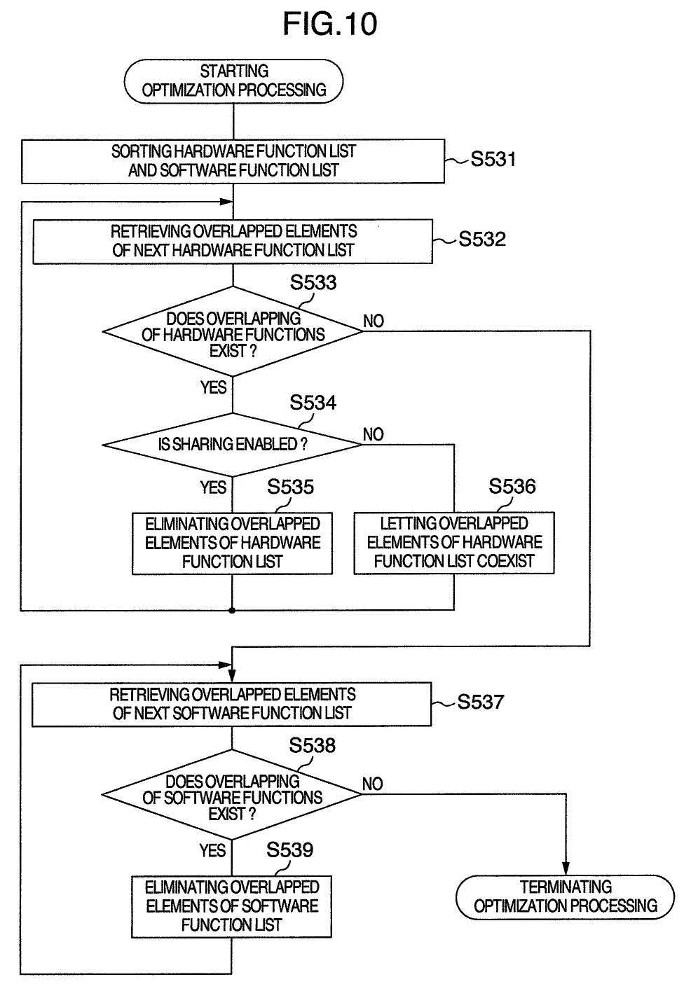

FIG. 10 is a diagram for illustrating detailed processing flow of the optimization processing indicated at S530 in FIG. 3. Incidentally, all the operations illustrated in FIG. 10 are performed by the optimization function 240 of the extraction unit 180.

First, the extraction unit 180 sorts the hardware function list created by the selection processing in FIG. 9, using the hardware function names as its key (e.g., sorts the hardware function names in the ascending sequence). As a result, the unit 180 arranges the sequence of the elements of the hardware function list. Also, the extraction unit 180 sorts the software function list created by the selection processing in FIG. 9, using the software function names as its key. As a result, the unit 180 arranges the sequence of the elements of the software function list (S531).

Next, out of the hardware function list sorted at S531, the extraction unit 180 sequentially retrieves a list where the hardware function names are overlapped (S532). Incidentally, the sorting has been finished at S531. Accordingly, if there exist overlapped hardware functions, it turns out that the overlapped hardware functions come to appear continuously on the hardware function list.

Next, if the list where the hardware function names are overlapped exists on the hardware function list, the extraction unit 180 proceeds to a processing at S534. Meanwhile, if the list where the hardware function names are overlapped does not exist thereon, the extraction unit 180 proceeds to a processing at S537 (S533).

Next, the explanation will be given below regarding S534 to which the extraction unit 180 is to proceed if the overlapped hardware functions are found to exist on the hardware function list. At S534, the extraction unit 180 judges whether or not the overlapped hardware functions are sharing-enabled. Moreover, if the extraction unit 180 judges that the overlapped hardware functions are sharing-enabled, the extraction unit 180 proceeds to a processing at S535. Meanwhile, if the extraction unit 180 judges that the functions are sharing-disabled, the extraction unit 180 proceeds to a processing at S536.

Concretely, the extraction unit 180 identifies the overlapped hardware functions. Furthermore, the extraction unit 180 makes access to the hardware-parts DB 100 (refer to FIG. 4). Then, the unit 180 makes reference to the sharing-enabled flag registered in the field 106 of the record in which data indicating the identified hardware functions is registered, thereby judging whether or not the overlapped hardware functions are sharing-enabled. Namely, if the sharing-disabled flag (No) indicating the sharing-disabled property is registered in the field 106 of the record in which the corresponding hardware functions are registered, it is judged that the hardware functions are sharing-disabled. Meanwhile, if the sharing-enabled flag (Yes) indicating the sharing-enabled property is registered in the field 106 of the record in which the corresponding hardware functions are registered, it is judged that the hardware functions are sharing-enabled.

At S535, the extraction unit 180 eliminates the overlapped hardware functions in the hardware function list, thereby modifying the hardware function list such that only one hardware function will remain. After that, the extraction unit 180 returns to the processing at S532.

Meanwhile, at S536, the extraction unit 180 lets the overlapped hardware functions in the hardware function list coexist with no modification made thereto. Namely, the extraction unit 180 returns to the processing at S532 without modifying the hardware function list.

Next, the explanation will be given below regarding processings after S537.

At S537, out of the software function list sorted at S531, the extraction unit 180 sequentially retrieves a list where the software function names are overlapped. Incidentally, the sorting has been finished at S531. Accordingly, if there exist overlapped software functions, it turns out that the overlapped software functions come to appear continuously on the software function list.

In addition, if the list where the software function names are overlapped exists on the software function list, the extraction unit 180 proceeds to a processing at S539. Meanwhile, if the list where the software function names are overlapped does not exist thereon, the extraction unit 180 terminates the optimization processing (S538).

At S539, i.e., when the overlapped software functions are found to exist, the extraction unit 180 regards the software as being basically sharing-enabled. Consequently, the extraction unit 180 eliminates the overlapped software functions, thereby modifying the software function list such that only one software function will remain.

Here, if the software is regarded as being sharing-disabled for the conveniences of exclusive control within the software or setting of memory resource, the following processing becomes necessary: Concretely, as is the case with the hardware-parts DB 100, in the software-parts DB 120, a sharing-enabled flag is provided for each software function, then being set for each software function. Based thereon, the sharing-enabled flags are checked for the overlapped software functions each. Moreover, if the overlapped software functions are sharing-enabled, basically the same processing as the one at S539 is performed thereto. Meanwhile, if the overlapped software functions are sharing-disabled, the software function list is not updated without eliminating the overlapped software functions. At this time, in order to exclusively use the software or locate the software on the memory, the setting needs to be performed exclusively using parameters.

Also, in the processings at S532 and S537, there exists a case where, although the functions are the same, the versions are different. As examples of the solving methods for solving such a case where the versions are different (i.e., version difference), conceivable solving methods are “giving priority to the newest or oldest version” or “letting all the functions coexist without executing the elimination”. If the version difference like this has occurred, it is preferable to include a message for calling attention into the hardware design data 260 and the software design data 280 which are to be outputted. Incidentally, these solving methods can be re-formed into automatic processings by notifying in advance the optimization function 240 of these solving methods as the optimization policy.

With respect to the overlapped hardware functions and the overlapped software functions, the above-described processings allow the optimization function 240 to eliminate the sharing-enabled functions, and to let the sharing-disabled functions coexist.

Next, the detailed explanation will be given below concerning the output processing indicated at S550 in FIG. 3.

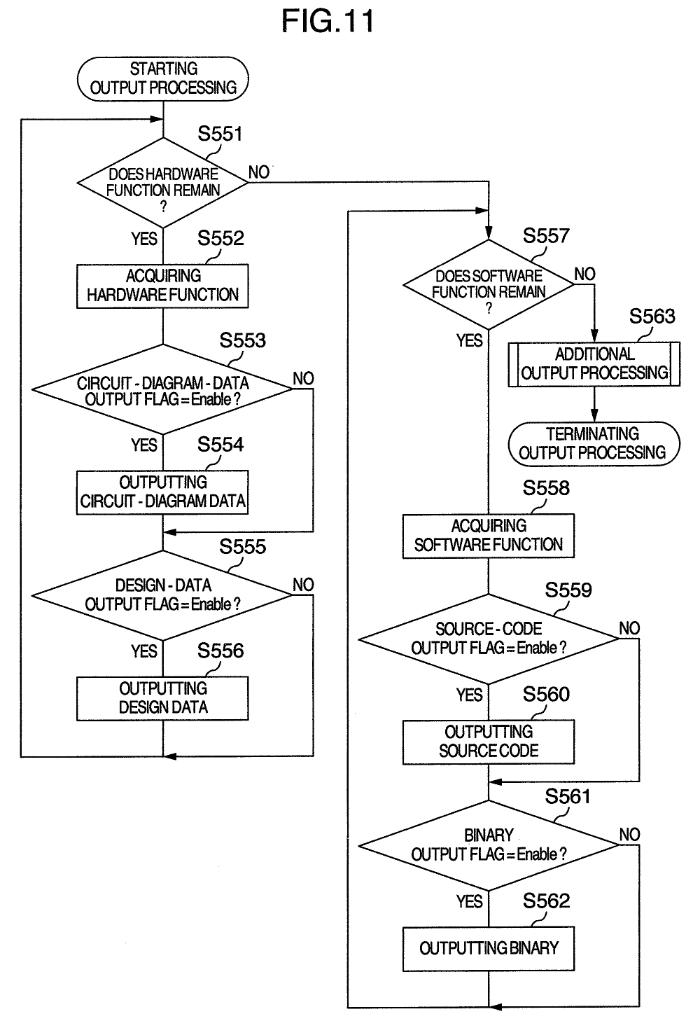

FIG. 11 is a diagram for illustrating detailed processing flow of the output processing indicated at S550 in FIG. 3. Incidentally, all the operations illustrated in FIG. 11 are performed by the output function 250 of the extraction unit 180.

First, the extraction unit 180 sequentially performs processings at S551 to S556 to the respective hardware functions registered in the hardware function list optimized by the optimization processing illustrated in FIG. 10. Moreover, when the extraction unit 180 has executed the processings at S551 to S556 to all of the hardware functions registered, the unit 180 proceeds to a processing at S557.

Concretely, the extraction unit 180 checks the hardware function list optimized by the optimization processing illustrated in FIG. 10, thereby confirming whether or not a hardware function to be outputted exists (S551). If, as a result of the confirmation, the hardware function to be outputted does not exist, the extraction unit 180 proceeds to the processing at S557. Meanwhile, if the hardware function to be outputted exists, the unit 180 proceeds to the processing at S552.

At S552, i.e., when the hardware function to be outputted exists, the extraction unit 180 acquires the hardware function from the hardware function list.

Next, the extraction unit 180 checks the value of the circuit-diagram-data output flag set for the hardware function acquired at S552 (S553).

Moreover, if the checked value of the flag is the circuit-diagram-data not-outputting value (i.e., Disable), the extraction unit 180 proceeds to the processing at S555. Meanwhile, if the checked value of the flag is the circuit-diagram-data outputting value (i.e., Enable), the extraction unit 180 proceeds to the processing at S554.

At S554, the extraction unit 180 reads, from the hardware-parts DB 100, the circuit-diagram data caused to correspond to the hardware function acquired at S552. Furthermore, the extraction unit 180 outputs the read circuit-diagram data to the hardware design data 260 of the computer development apparatus 1, and desirably, to a predetermined directory (e.g., /result/edif/) of the file system that the computer development apparatus 1 includes.

Next, the extraction unit 180 checks the value of the design-data output flag set for the hardware function acquired at S552 (S555). Moreover, if the checked value of the design-data output flag is the design-data not-outputting value (i.e., Disable), the extraction unit 180 returns to the processing at S551. Meanwhile, if the checked value of the flag is the design-data outputting value (i.e., Enable), the extraction unit 180 proceeds to the processing at S556.

At S556, the extraction unit 180 reads, from the hardware-parts DB 100, the design data caused to correspond to the hardware function acquired at S552. Furthermore, the extraction unit 180 outputs the read design data to the hardware design data 260 of the computer development apparatus 1, and desirably, to a predetermined directory (e.g., /result/design/) of the file system that the computer development apparatus 1 includes.

In addition, the extraction unit 180 returns to the processing at S551. Then, if the unit 180 judges that the hardware function to be outputted does not exist, the unit 180 proceeds to the processing at S557. Namely, when the unit 180 has terminated the hardware-function output processings, the unit 180 transitions to software-function output processings after S557.

Next, the explanation will be given below regarding the processings after S557. The extraction unit 180 sequentially performs processings at S557 to S562 to the respective software functions registered in the software function list optimized by the optimization processing illustrated in FIG. 10. Moreover, when the extraction unit 180 has executed the processings at S557 to S562 to all of the software functions registered, the unit 180 proceeds to a processing at S563.

Concretely, at S557, the extraction unit 180 checks the software function list optimized by the optimization processing, thereby confirming whether or not a software function to be outputted exists. If, as a result of the confirmation, the software function to be outputted does not exist, the extraction unit 180 proceeds to the processing at S563. Meanwhile, if the software function to be outputted exists, the unit 180 proceeds to the processing at S558.

Moreover, if, at S557, the extraction unit 180 judges that the software function to be outputted does not exist, the unit 180 executes an additional processing at S563, then terminating the output processing. Incidentally, since no specific processing to be executed at S563 exists in the first embodiment, the unit 180 terminates the output processing with no additional processing executed.

Next, the explanation will be given below concerning the processings after S558, to which the extraction unit 180 is to proceed if, at S557, the unit 180 judges that the software function to be outputted exists. First, at S558, the extraction unit 180 acquires the software function from the software function list.

Next, the extraction unit 180 checks the value of the source-code output flag set for the software function acquired at S558 (S559). Moreover, if the checked value of the source-code output flag is the source-code not-outputting value (i.e., Disable), the extraction unit 180 proceeds to the processing at S561. Meanwhile, if the checked value of the flag is the source-code outputting value (i.e., Enable), the extraction unit 180 proceeds to the processing at S560.

At S560, the extraction unit 180 reads, from the software-parts DB 120, the source code caused to correspond to the software function acquired at S558. Furthermore, the extraction unit 180 outputs the read source code to the software design data 280 of the computer development apparatus 1, and desirably, to a predetermined directory (e.g., /result/source/) of the file system that the computer development apparatus 1 includes. Then, the extraction unit 180 proceeds to the processing at S561.

At S561, the extraction unit 180 checks the value of the binary output flag set for the software function acquired at S558. Moreover, if the checked value of the binary output flag is the binary not-outputting value (i.e., Disable), the extraction unit 180 returns to the processing at S557. Meanwhile, if the checked value of the binary output flag is the binary outputting value (i.e., Enable), the extraction unit 180 proceeds to the processing at S562.

At S562, the extraction unit 180 reads, from the software-parts DB 120, the binary caused to correspond to the software function acquired at S558.

Furthermore, the extraction unit 180 outputs the read binary to the software design data 280 of the computer development apparatus 1, and desirably, to a predetermined directory (e.g., /result/binary/) of the file system that the computer development apparatus 1 includes. Then, the extraction unit 180 returns to the processing at S557. At this time, with the predetermined directory as the reference, it is preferable to store the binary file into a specified hierarchy of the installation position registered in the field 127 of the corresponding record of the software-parts DB 120.

The above-described processings allow the output function 250 to output the design data on the optimized hardware parts and the design data on the optimized software parts as the hardware design data 260 and the software design data 280.

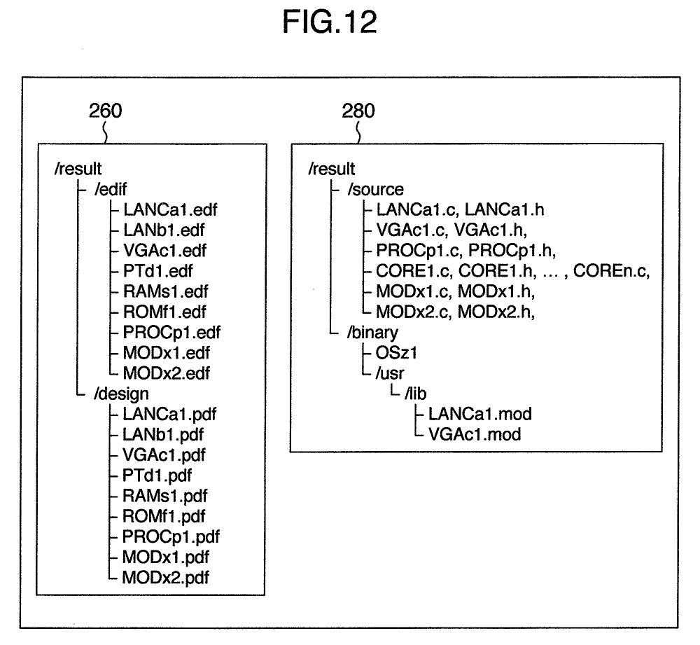

Subsequently, FIG. 12 illustrates an example of the hardware design data 260 and the software design data 280 outputted by the extraction unit 180 in the present embodiment.

Incidentally, the illustrated example indicates a case of developing a computer apparatus where the computer functions “MODx1” and “MODx2” are fused and mixed. Namely, the illustrated example indicates an example of the design data which will be outputted in the case where the record where “MODx1” is registered and the record where “MODx2” is registered are set in the constraint condition 160. Incidentally, hereinafter, all of the flags to be registered into the constraint condition 160 are set as being “Enable”.

Based on the above-described constraint condition 160, the extraction unit 180 extracts the hardware functions and the software functions related with the computer functions “MODx1” and “MODx2”, using the selection function 220 and the optimization function 240. Regarding the hardware functions, the sharing-enabled hardware parts (PROCp1HW, RAMs1HW, ROMf1HW) and the sharing-disabled hardware parts (LANCa1HW, PTd1HW, VGAc1HW) are extracted. Also, regarding the software functions, LANCa1SW, VGAc1SW, PROCp1SW, OSz1SW, MODx1SW, MODx2SW are extracted.

Moreover, the extraction unit 180 outputs the hardware design data 260 and the software design data 280 illustrated in FIG. 12, using the output function 250 and based on the above-described extraction results and the respective flags registered in the constraint condition 160.

In this way, according to the first embodiment of the present invention, from the information in the hardware-parts DB 100, the software-parts DB 120, and the relation DB 140, it becomes possible to acquire the hardware design data and the software design data related with the constraint condition 160 given to the computer development apparatus 1. Namely, according to the first embodiment, the developer finds it possible to acquire the design data on a development-target computer only by a simple task of setting desired functions of the development-target computer into the computer development apparatus 1. Incidentally, the outputted design data also includes the data on the software parts corresponding to the hardware parts for implementing the desired functions. Also, in the first embodiment, the optimization processing illustrated in FIG. 10 permits the design data to be represented in its smallest configuration corresponding to the sharing-enabled parts and the sharing-disabled parts.

On account of this feature, even in the case of a developer who is not very familiar with how to use the hardware design resources and the software design resources, the utilization of the computer development apparatus 1 in the first embodiment allows the developer to easily design both of the hardware parts and the software parts of a computer apparatus.

### 2ND EMBODIMENT

Next, the explanation will be given below concerning a second embodiment of the present invention. Incidentally, in the explanation of the second embodiment, the same reference numerals will be used for the same configuration components as the ones in the above-described first embodiment unless otherwise specified.

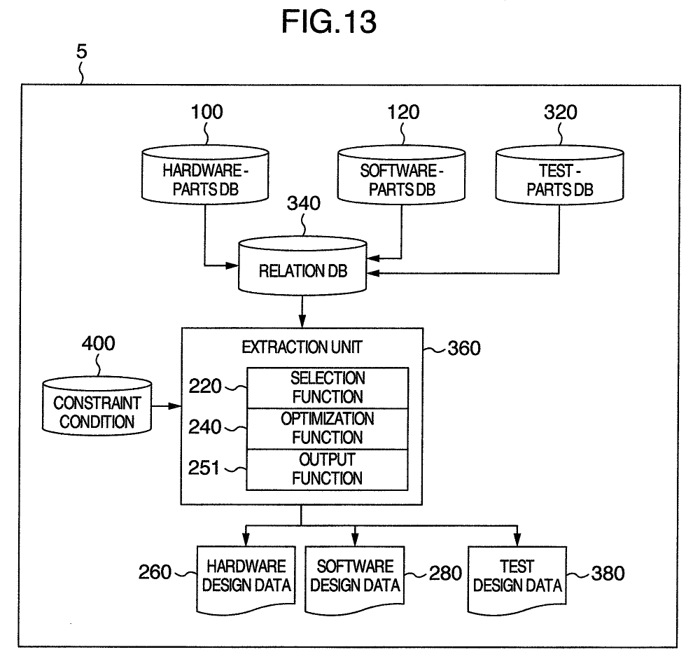

FIG. 13 is a functional block diagram for illustrating configuration of the computer development apparatus in the second embodiment of the present invention. In the second embodiment, in addition to the functions in the first embodiment, a function of creating and outputting test design data 380, which will be described later, is further added. In the second embodiment, in order to create and output the test design data 380, a test-parts DB 320 is added to the configuration in the first embodiment. Moreover, in accompaniment therewith, configuration of a relation DB 340, that of a constraint condition 400, and function of an extraction unit 360 are partially modified. Incidentally, in order to make the distinction from the computer development apparatus 1 in the first embodiment, the computer development apparatus in the second embodiment is referred to as the computer development apparatus 5. Additionally, in the explanation of the second embodiment, the explanation of the same configuration components as the ones in the first embodiment will be simplified, and the explanation will be given below with the different configuration components as its center.

Concretely, the computer development apparatus 5 in the second embodiment includes the hardware-parts DB 100, the software-parts DB 120, the test-parts DB 320, the relation DB 340, the constraint condition 400, and the extraction unit 360. The extraction unit 360 includes three functions, i.e., the selection function 220, the optimization function 240, and an output function 251.

The test-parts DB 320 is a database for storing information on test programs (hereinafter, referred to as test parts) necessary for checking predetermined functions of a computer. The relation DB 340 is a database where data for making the test-parts DB 320 related with the data configuration of the relation DB 140 in the first embodiment are further added thereto. The constraint condition 400 is a file where data for making the test-parts DB 320 related with the data configuration of the constraint condition 160 in the first embodiment are further added thereto. Incidentally, configuration of these databases will be explained in detail later.

Using the constraint condition 400 set by the developer and the data stored in the respective databases (the hardware-parts DB 100, the software-parts DB 120, the test-parts DB 320, and the relation DB 340), the extraction unit 360 extracts hardware parts and software parts needed for a development-target computer and the test parts, then converting the extracted parts as required. Namely, the difference between the extraction unit 360 in the second embodiment and the extraction unit 180 in the first embodiment is that the function for extracting and outputting the test parts is added. The extraction unit 360 outputs the respective extracted and converted results as the hardware design data 260, the software design data 280, and the test design data 380.

In this way, in the second embodiment, as is the case with the first embodiment, the developer selects a computer function needed for the development-target computer via the constraint condition 400. The computer development apparatus 5 outputs data on the hardware parts and software parts which are related with the computer function selected by the constraint condition 400, and data indicating the test parts. Namely, according to the second embodiment, only by setting the constraint condition 400, the developer finds it possible to acquire the data on the hardware parts and software parts for implementing the computer function needed for the development-target computer, and the data on the test parts.

Next, the explanation will be given below regarding hardware configuration of the computer development apparatus 5 in the second embodiment of the present invention.

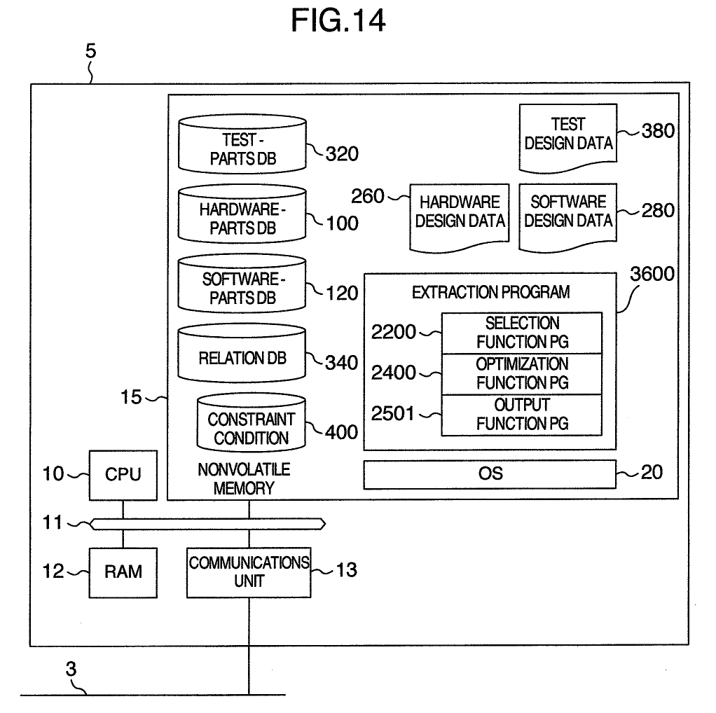

FIG. 14 is a diagram for illustrating an example of the hardware configuration of the computer development apparatus 5 in the second embodiment of the present invention. Incidentally, the hardware configuration of the computer development apparatus 5 illustrated in FIG. 14 is the same as the hardware configuration illustrated in FIG. 2 except that part of the data stored in the nonvolatile memories differ from each other.

Concretely, the computer development apparatus 5 includes the CPU 10, the internal bus 11, the RAM (Random Access Memory) 12, the communications unit 13, and the nonvolatile memory 15. In the nonvolatile memory 15, in addition to the data stored in the nonvolatile memory 14 in the first embodiment, the newly added test-parts DB 320 and test design data 380 are stored. Furthermore, the functions of the extraction unit 360 in the second embodiment are implemented by the CPU 10 in such a manner that the CPU 10 loads, onto the RAM 12, and executes the OS 20, an extraction program 3600, and the respective types of information stored in the nonvolatile memory 15.

Next, the explanation will be given below regarding data configuration of the test-parts DB 320 in the second embodiment.

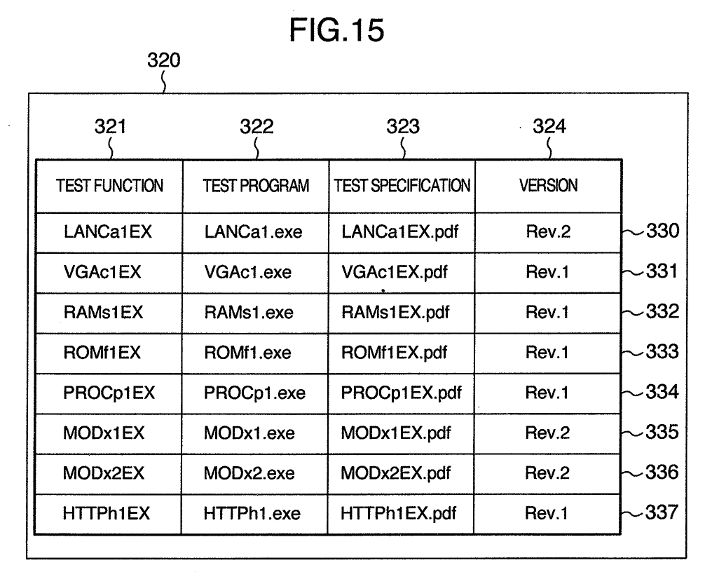

FIG. 15 is a diagram for schematically illustrating the data configuration of the test-parts DB 320 in the second embodiment of the present invention.

One record of the test-parts DB 320 is constituted by a field 321 for registering test function, a field 322 for registering test program, a field 323 for registering test specification, and a field 324 for registering version.

The test function, which is registered into the field 321, is an index on a test part (i.e., identification information for identifying the test part).

The test program, which is registered into the field 322, is a program for checking a hardware part or software part. It is possible to describe a plurality of test programs which are necessary for the checking. Incidentally, although, in the present embodiment, an execution file of the file extension “exe” is employed as the example, the document file is not limited thereto, and may be a script file or a document describing the execution steps therein.

The test specification, which is registered into the field 323, is a document that describes therein explanatory note on precondition, checking policy, and execution method which become necessary when checking the hardware part or software part becoming target of the test program.

The version, which is registered into the field 324, is data used when managing the test function, and represents history of the test function.

The illustrated test-parts DB 320 indicates an example where the following data is registered in each record. In a record 330, data on “LANCa1EX” for testing function of the LAN controller is registered.

In a record 331, data on “VGAc1EX” for testing function of the screen-output controlling VGA chip is registered. In a record 332, data on “RAMs1EX” for testing function of the RAM is registered. In a record 333, data on “ROMf1EX” for testing function of the ROM is registered. In a record 334, data on “PROCp1EX” for testing function of the CPU is registered. In a record 335 (336), data on “MODx1 (MODx2)” for testing function of the computer module is registered.

Moreover, in, e.g., the record 330, the test-parts DB 320 indicates that, with respect to “LANCa1EX”, the test program is “LANCa1.exe”, the test specification is “LANCa1EX.pdf”, and the version is “Rev. 2 (revision 2)”.

By configuring the test-parts DB 320 as described above, concerning the functions related with the configuration elements of the computer, it becomes possible to know the corresponding test program or test methodology.

Next, the explanation will be given below regarding data configuration of the relation DB 340 in the second embodiment.

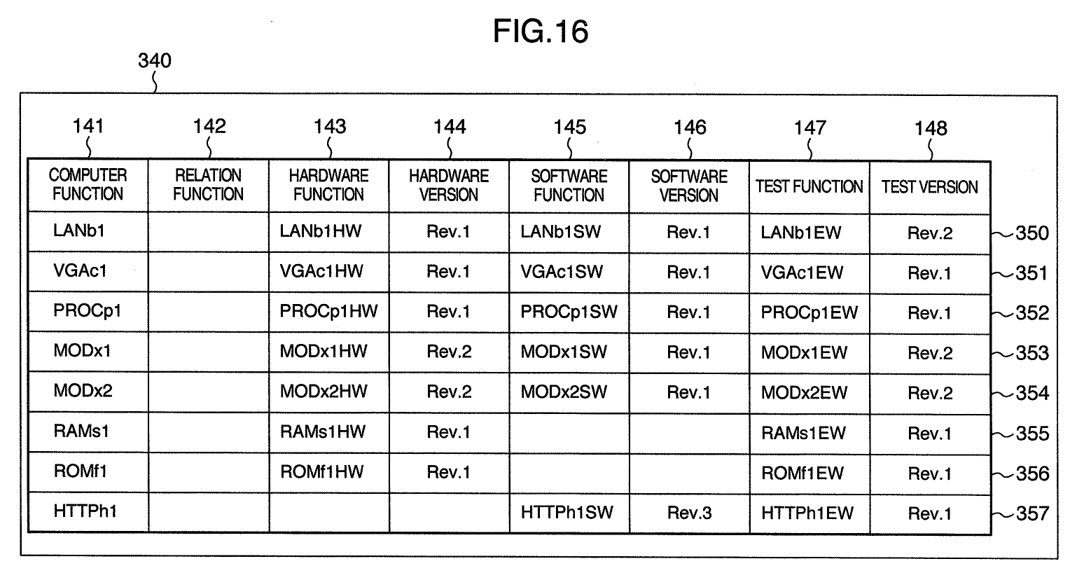

FIG. 16 is a diagram for schematically illustrating the data configuration of the relation DB 340 in the second embodiment of the present invention. Incidentally, the difference between the relation DB 340 in the second embodiment and the relation DB 140 in the first embodiment is the following point: Data for registering the test function and data for registering the test version, i.e., elements for establishing the relation with the test function, are added.

Concretely, one record of the relation DB 340 is constituted by the same fields 141 to 146 as the ones of the record of the relation DB 140 in the first embodiment, a field 147 for registering the test function, and a field 148 for registering the test version.

The feature of the relation DB 340 is that, in one record, the hardware function, the software function, and the test function are registered in a manner of being caused to correspond to the computer function. Also, even when the combinations of the hardware function, the software function, and the test function are the same, if the respective versions are different, these functions may be managed using different records.

By configuring the relation DB 340 as described above, it becomes possible to know the relation among the hardware function, the software function, and the test function corresponding to the computer function.

Next, the explanation will be given below concerning the constraint condition 400 in the computer development apparatus 5 in the second embodiment.

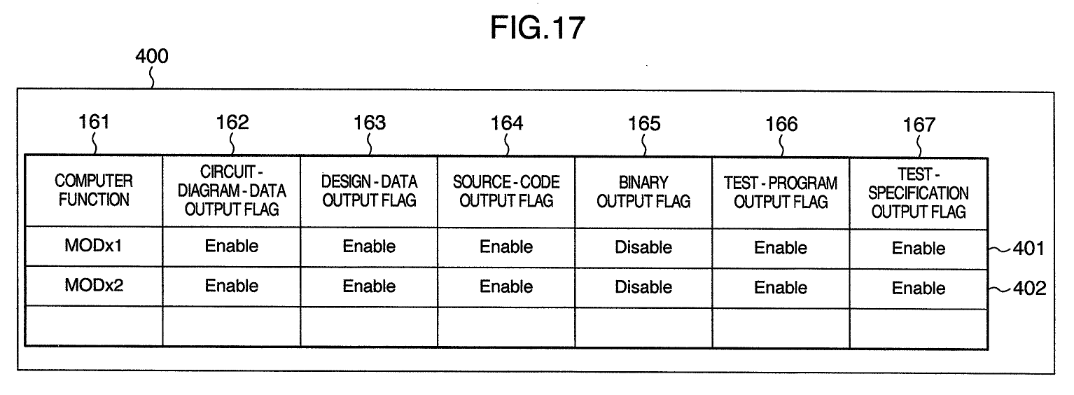

FIG. 17 is a diagram for schematically illustrating data configuration of the constraint condition 400 in the computer development apparatus 5 in the second embodiment of the present invention.

As illustrated in FIG. 17, the constraint condition 400 in the second embodiment is a condition that a flag (test-program output flag) for specifying whether or not to output the test program and a flag (test-specification output flag) for specifying whether or not to output the test specification are added to the constraint condition 160 in the first embodiment. Concretely, one record of the constraint condition 400 is constituted by the same fields 161 to 165 as the ones of the record of the constraint condition 160 in the first embodiment, a field 166 for registering the test-program output flag, and a field 167 for registering the test-specification output flag.

For example, in a record 401, the respective flags instruct the following constraint condition: With respect to the computer function “MODx1”, only the binary is not outputted (described as being “Disable”), and all the others are outputted (described as being “Enable”).

Subsequently, the explanation will be given below concerning the operation of the extraction unit 360 in the second embodiment of the present invention. The extraction unit 360 in the second embodiment is the same as the one in the first embodiment except that the processing performed by the output function 251 differs from the one in the first embodiment.

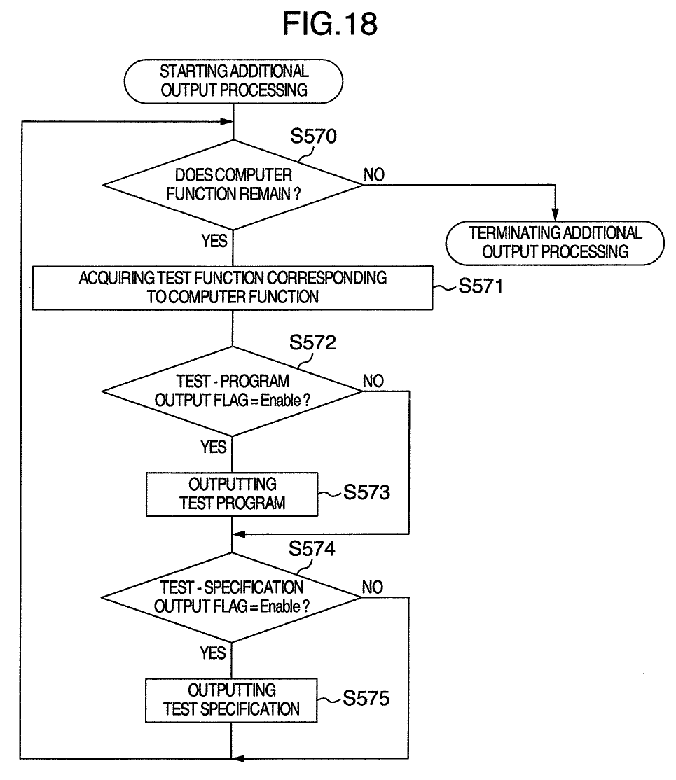

Concretely, the extraction unit 360 in the second embodiment performs a selection processing in accordance with basically the same steps as the ones illustrated in FIG. 9. Also, the extraction unit 360 performs an optimization processing in accordance with basically the same steps as the ones illustrated in FIG. 10. Also, at S563 of the output processing illustrated in FIG. 11, the extraction unit 360 performs an additional output processing illustrated in FIG. 18.

Incidentally, in the second embodiment, it is assumed that the extraction unit 360 includes the test-program output flag and the test-specification output flag, which are specified in the constraint condition 400, into the computer function list created at S511 in FIG. 9. Namely, in the computer function list in the second embodiment, the test-program output flag and the test-specification output flag are also caused to correspond to each computer function. Hereinafter, the additional output processing in the second embodiment is illustrated in FIG. 18.

FIG. 18 is a diagram for illustrating detailed processing flow of the additional output processing performed in the second embodiment of the present invention. This additional output processing is the processing performed at S563 in FIG. 11. Incidentally, the following operations are performed by the output function 251 of the extraction unit 360.

In FIG. 18, the extraction unit 360 makes reference to the computer function list, then sequentially performing processings at S570 to S575 to the data indicating the computer functions registered in the computer function list (e.g., performing the processings sequentially from the above of the list). Moreover, when the extraction unit 360 has successfully processed all of the data indicating the computer functions registered in the computer function list, the extraction unit 360 terminates the additional output processing.

Concretely, the extraction unit 360 makes reference to the computer function list created at S511 in FIG. 9, thereby confirming whether or not there exists at least one computer function to be subjected to the output processing (S570). Furthermore, if there exists no computer function to be subjected to the output processing, the unit 360 terminates the additional output processing. Meanwhile, if there exists at least one computer function to be subjected to the output processing, the unit 360 identifies at least one computer function to be outputted (e.g., identifies at least one computer function sequentially from the above of the list), then proceeding to the processing at S571.

At S571, the extraction unit 360 acquires the test function corresponding to at least one computer function identified (S571). Concretely, the extraction unit 360 makes access to the relation DB 340, then retrieving, from the records registered in the relation DB 340, a record in which the identified computer-function indicating data is registered. Then, the extraction unit 360 extracts the test function from the record retrieved.

Next, the extraction unit 360 checks the value of the test-program output flag set for the identified test function (S572). Concretely, the extraction unit 360 makes reference to the computer function list, then making reference to the value of the test-program output flag which is caused to correspond to the identified test function. Moreover, if the test-program output flag is the test-program not-outputting value (i.e., value of the flag is Disable), the unit 360 branches to S574. Meanwhile, if the flag is the test-program outputting value (i.e., value of the flag is Enable), the unit 360 proceeds to S573.

At S573, the extraction unit 360 outputs the test program. For example, the extraction unit 360 outputs the test program to a predetermined directory (e.g., /result/testprog/) of the file system that the computer development apparatus 5 includes.

Next, the extraction unit 360 checks the value of the test-specification output flag set for the identified test function (S574). Concretely, the extraction unit 360 makes reference to the computer function list, then making reference to the value of the test-specification output flag which is caused to correspond to the identified test function.

Furthermore, if the test-specification output flag is the test-specification not-outputting value (i.e., value of the flag is Disable), the unit 360 returns to S570. Meanwhile, if the flag is the test-specification outputting value (i.e., value of the flag is Enable), the unit 360 proceeds to S575.

At S575, the extraction unit 360 outputs the test specification. For example, the extraction unit 360 outputs the test specification to a predetermined directory (e.g., /result/testspec/) of the file system that the computer development apparatus 5 includes.

Incidentally, when outputting the test design data 380, there can exist the case where, although the combinations of the hardware function, the software function, and the test function described in the relation DB 340 are the same, the respective versions are incompatible with each other. At that time, when generating the test design data 380, it is preferable to include a message into the test design data 380 for calling attention to the developer. At this time, regarding the test program and the test specification to be outputted, examples of employable methods are as follows: “Outputting test part of the newest version”, “outputting all test parts”, or “giving priority to version of software part, and outputting test part compatible therewith”.

The above-described processings allow the output function 251 to output the design data on the test parts in addition to the design data on the optimized hardware parts and software parts.

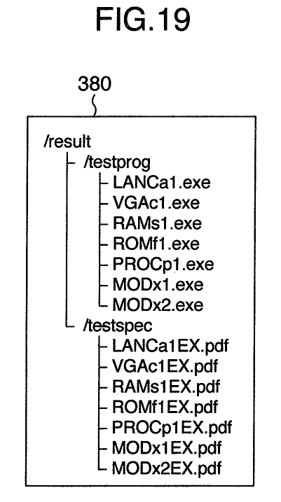

Subsequently, FIG. 19 illustrates an example of the test design data 380 outputted by the extraction unit 360 in the second embodiment.

Incidentally, the illustrated example indicates a case of developing a computer apparatus where the computer functions “MODx1” and “MODx2” are fused and mixed. Namely, the illustrated example indicates an example of the design data which will be outputted in the case where the record where “MODx1” is registered and the record where “MODx2” is registered are set in the constraint condition 400. Incidentally, all of the flags to be registered into the constraint condition 400 are set as being “Enable”.

Based on the above-described constraint condition 400, the extraction unit 360 outputs the test design data 380 in addition to the hardware design data 260 and the software design data 280. Furthermore, the test design data 380 is outputted in a manner exactly as is illustrated in FIG. 19. Incidentally, the hardware design data 260 and the software design data 280 are exactly as are illustrated in FIG. 12.

In this way, according to the second embodiment of the present invention, from the information in the hardware-parts DB 100, the software-parts DB 120, the test-parts DB 320, and the relation DB 340, it becomes possible to acquire the hardware design data and the software design data related with the constraint condition 400 given to the computer development apparatus 5, and the design data for the test. Only by setting development-target computer functions into the constraint condition 400, the developer finds it possible to acquire the test design data in addition to the hardware and software design data on a development-target computer.

On account of this feature, according to the second embodiment of the present invention, it also becomes possible to utilize past resources with respect to the checking at the time of developing a new apparatus. As a result, it becomes possible to tremendously reduce the burden at the time of reusing the hardware parts and software parts related. Namely, according to the second embodiment, it becomes possible to construct the mechanism for checking the designed computer in addition to the effects obtained in the first embodiment. This feature allows the development of a high-performance computer.

### 3RD EMBODIMENT

Next, the explanation will be given below concerning a third embodiment of the present invention. Incidentally, in the explanation of the third embodiment, the same reference numerals will be used for the same configuration components as the ones in the above-described first and second embodiments unless otherwise specified. Additionally, although an example based on the configuration of the second embodiment will be presented in the third embodiment, it is also possible to apply the third embodiment to the configuration of the first embodiment.

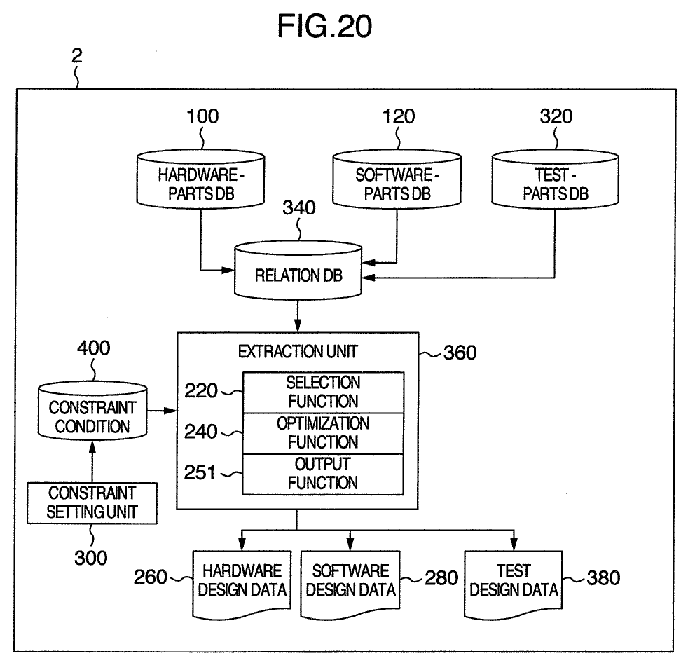

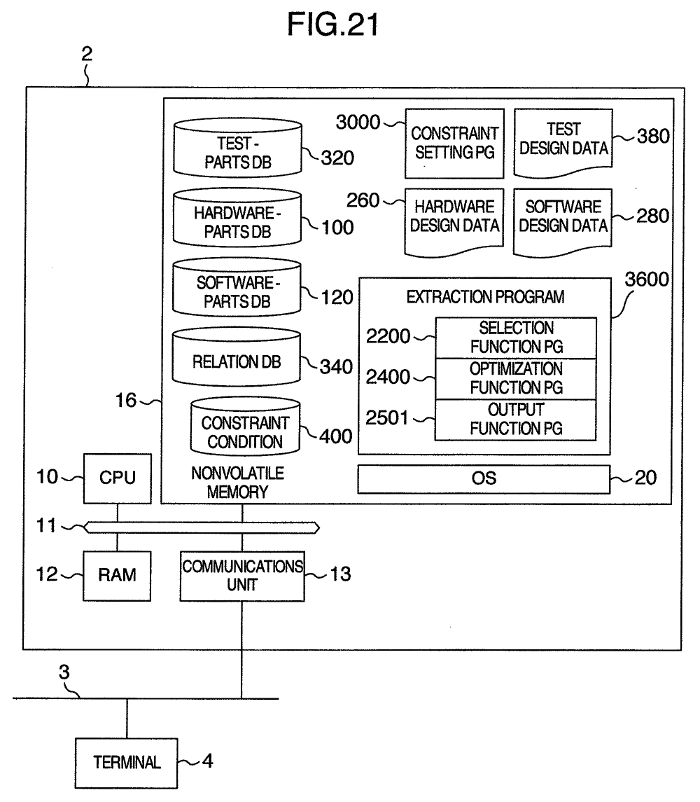

FIG. 20 and FIG. 21 illustrate the configuration of the third embodiment of the present invention. FIG. 20 is a functional block diagram for illustrating the computer development apparatus in the third embodiment of the present invention. FIG. 21 is a diagram for illustrating an example of hardware configuration of the computer development apparatus in the third embodiment of the present invention.

The feature of the third embodiment is as flows: Namely, a terminal 4 connected to the network 3 is newly introduced, then providing a constraint setting unit 300 in the computer development apparatus 2.

Concretely, as illustrated in FIG. 20, the computer development apparatus 2 in the third embodiment results from adding the constraint setting unit 300 to the configuration of the computer development apparatus 5 in the second embodiment.

The constraint setting unit 300 is a unit for setting the constraint condition 400 of the computer development apparatus 2 from the terminal 4 (refer to FIG. 21) connected to the network 3. Namely, the constraint setting unit 300 receives data or each type of request from the terminal 4, thereby performing setting of the constraint condition 400.

Also, as illustrated in FIG. 21, the hardware configuration of the third embodiment is the same as the one of the second embodiment except for the following two points: Data stored in a nonvolatile memory 16 partially differs from the data stored in the second embodiment, and the terminal 4 is connected to the network 3. Concretely, in the nonvolatile memory 16 that the computer development apparatus 2 includes, a program (constraint setting program 3000) for implementing functions of the constraint setting unit 300 is stored in addition to the respective types of data and programs stored in the nonvolatile memory 15 (refer to FIG. 14) in the second embodiment.

The terminal 4 is a computer for communicating with the constraint setting unit 300 of the computer development apparatus 2, and setting the constraint condition 400. The terminal 4 has a function of receiving an input from the user to establish the connection with a development-target computer, a function of displaying a set value of the present constraint condition 400, and a function of adding and modifying the set value. Also, the terminal 4 has an interface capable of establishing connection with the network 3. Incidentally, concrete configuration of the terminal 4 is not limited specifically. As the terminal 4, whatever computer is usable as long as it has the function of receiving an input from the user, communicating with the constraint setting unit 300 of the computer development apparatus 2, and being capable of setting the constraint condition 400 via the constraint setting unit 300. For example, a computer (e.g., personal computer (PC) or work station) equipped with a HTTP-data-input/output-capable Web browser is usable as the terminal 4. Also, by appropriately limiting information to be inputted/outputted into/from the Web browser, a Web browser with which a mobile telephone or PDA (Personal Digital Assistant) is equipped may be used.

Incidentally, although, in the present embodiment, the terminal 4 will be explained on the assumption that it has the interface capable of establishing connection with the network 3, the interface is not limited to this assumption. For example, employing the following configuration does not impair effects of the present embodiment: A serial-transmission-equipped terminal such as RS232C or RS422 is used as the terminal 4. Then, this terminal is so configured as to be directly connected to the computer development apparatus 2 without intervention of the network 3. Moreover, the connection is established between these computers by a communications scheme such as SLIP (Serial Line Internet Protocol) or PPP (Point to Point Protocol).

Also, although, in the third embodiment, the terminal 4 will be explained as an independent computer, the computer development apparatus 2 may also have the function of the terminal 4. In that case, each computer requires a screen output unit (not illustrated) needed for the setting. Also, the computer equipped with the function of the terminal 4 is equipped with input units (not illustrated) such as a pointing device, e.g., mouse or tracking ball, and keyboard.

Next, the explanation will be given below concerning the operation of the terminal 4 and that of the constraint setting unit 300. The terminal 4 establishes the connection with the constraint setting unit 300 via the network 3. After that, the terminal 4 reads the set value held in the present constraint condition 400 via the constraint setting unit 300. The terminal 4 displays the read set value on the screen output unit (not illustrated) such as, e.g., a liquid-crystal display. While seeing the set value displayed on the screen output unit of the terminal 4, the developer inputs a modification instruction for the set value via the input unit of the terminal 4. Having received the modification instruction from the developer, the terminal 4 notifies the constraint setting unit 300 of the modification instruction for the set value. The constraint setting unit 300 modifies the set value of the constraint condition 400 in accordance with the modification instruction of which the unit 300 has been notified, then making a response with the modification result to the terminal 4.

Incidentally, the function of the constraint setting unit 300 is implemented by the CPU 10 in such a manner that the CPU 10 loads and executes the constraint setting program 3000 stored in the nonvolatile memory 16.

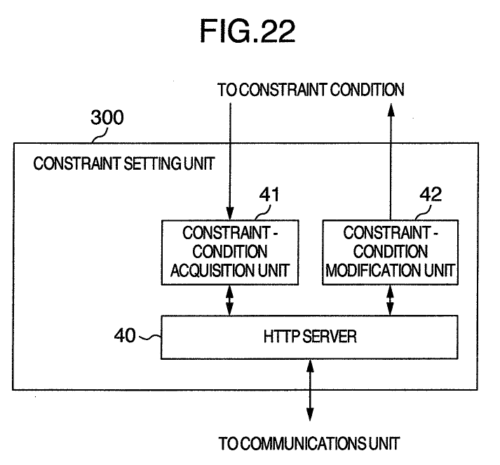

Here, referring to FIG. 22, the explanation will be given below regarding configuration example of the constraint setting unit 300.

FIG. 22 is a diagram for illustrating the configuration example of the constraint setting unit 300 in the third embodiment of the present invention.

As illustrated in FIG. 22, the constraint setting unit 300 includes a HTTP server 40, a constraint-condition acquisition unit 41, and a constraint-condition modification unit 42.

The HTTP server 40 performs communications with the terminal 4 to which the server 40 attains via the communications unit 13 and the network 3. Then, the HTTP server 40 makes a response to the connection request from the terminal 4.

In response to a request from the HTTP server 40, the constraint-condition acquisition unit 41 reads the set value held in the constraint condition 400, then outputting the read set value to the HTTP server 40. In response to a request from the HTTP server 40, the constraint-condition modification unit 42 modifies the value of the set value held in the constraint condition 400. Incidentally, the constraint-condition acquisition unit 41 and the constraint-condition modification unit 42, which are software parts for communicating with the HTTP server 40, are preferably implemented with CGI or servlet.

Concretely, when the HTTP server 40 is requested from the terminal 4 to acquire the constraint condition, the server 40 issues the constraint-condition acquisition request to the constraint-condition acquisition unit 41. The constraint-condition acquisition unit 41 reads the corresponding information from the constraint condition 400. Moreover, the acquisition unit 41 converts the format of the read information into a format viewable by the terminal 4, then answering and returning the converted information to the HTTP server 40. The HTTP server 40 receives the converted information answered by the constraint-condition acquisition unit 41, then returning a response with the received information to the terminal 4, i.e., the request source.

Also, when the HTTP server 40 is requested from the terminal 4 to modify the constraint condition, the server 40 issues the constraint-condition modification request to the constraint-condition modification unit 42. Based on the requested information to be modified, the constraint-condition modification unit 42 modifies the constraint condition 400.

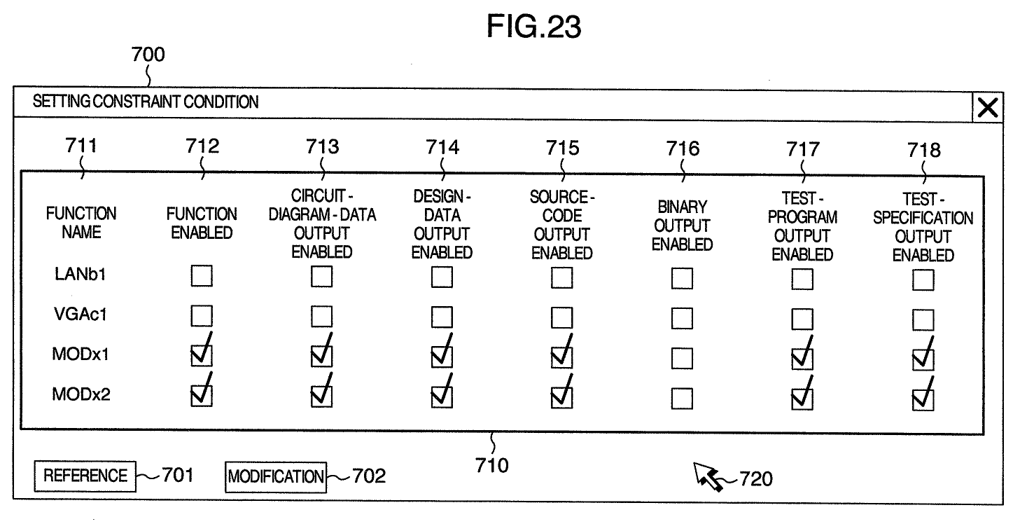

Subsequently, referring to FIG. 23, the explanation will be given below concerning a constraint-condition setting screen outputted at the terminal 4.

FIG. 23 is a diagram for illustrating an example of the constraint screen outputted at the terminal 4 in the third embodiment of the present invention.

Here, it is assumed that a constraint-condition setting tool for receiving the setting modification (or input of the set value) for the constraint condition 400 held in the computer development apparatus 2 is implemented in the terminal 4. Incidentally, in the illustrated example, an initial screen 700 of the constraint-condition setting tool is exemplified.

Incidentally, in the explanation hereinafter, a setting scheme using the constraint-condition-setting specific tool will be given and explained. It is also possible, however, to output basically the same screen by using the Web browser. In that case, it is preferable that initial screen information is held in advance in the terminal 4 or another computer (not illustrated), and that reference is made to the initial screen information at the time of starting up the Web browser.

Now, the constraint-condition setting screen 700 includes a reference button 701 for receiving a reference instruction for the constraint condition 400 held in the computer development apparatus 2, a modification button 702 for receiving the constraint-condition modification request, and a check screen 710 for selecting a computer function to be developed. Using the pointing device (not illustrated) connected to the terminal 4, such as mouse or tracking ball, the user operates and displaces a cursor 720 displayed on the constraint-condition setting screen 700, thereby selecting and pressing down a target button or a check button. This operation allows the user to set the constraint condition into the computer development apparatus 2.

Next, referring to the constraint-condition setting screen 700 displayed, the explanation will be given below regarding procedure steps by which the developer causes desired computer functions to be reflected on the constraint condition 400.

First, the developer presses down the reference button 701 on the constraint-condition setting screen 700 by operating the pointing device or the like connected to the terminal 4. This operation calls up the value of the present constraint condition 400 onto the check screen 710. Concretely, if the developer presses down the reference button 701, the terminal 4 communicates with the constraint setting unit 300 of the computer development apparatus 2, thereby acquiring the set value registered in the constraint condition 400. Incidentally, it is desirable for the constraint setting unit 300 to perform the following operation: Namely, when reading the set value of the constraint condition 400 in response to the request from the terminal 4, the unit 300 makes reference to the relation DB 340, thereby outputting, to the terminal 4, an item as well which is not included in the present constraint condition 400, but becomes the target of the constraint condition. Performing such an operation allows the terminal 4 to call up, onto the check screen 710, the item as well which is not included in the present constraint condition 400, but becomes the target of the constraint condition.

After that, the developer places a checkmark into checkboxes for registering function Enabled 712 corresponding to desired computer function name 711. Along therewith, the developer places a checkmark into checkboxes for registering circuit-diagram-data output Enabled 713 corresponding to necessary design data. Also, similarly, the developer places a checkmark into respective checkboxes for registering design-data output Enabled 714, source-code output Enabled 715, binary output Enabled 716, test-program output Enabled 717, and test-specification output Enabled 718.

After having completed the checking to the necessary design data, the developer presses down the modification button 702. Then, the terminal 4 notifies the constraint setting unit 300 of the computer development apparatus 2 about the design data specified by the developer. After that, the constraint setting unit 300 modifies the constraint condition 400 registered in the computer development apparatus 2.

Incidentally, by modifying the constraint condition 400 in the example of the checking items illustrated in FIG. 23, the developer is capable of obtaining the constraint condition 400.

As having been explained so far, according to the third embodiment of the present invention, even if the developer has no expert knowledge about the design-target computer functions, the developer finds it possible to add, modify, or delete the computer functions needed for a development-target computer only by selecting the checking items on the constraint-condition setting screen 700 while watching the screen 700 displayed on the display.

Incidentally, the present invention is not limited to the embodiments explained so far. Instead, the various modifications are possible within the range of the essence and spirit of the present invention.

For example, when outputting the design data extracted from the hardware-parts DB 100 and the software-parts DB 120, the extraction unit 180 makes reference to the hardware-parts DB 100, the software-parts DB 120, and the relation DB 140. Then, if versions of the extracted design data are different from the versions (hardware version and software version) specified in the relation DB 140, the extraction unit 180 may issue a warning message.

Also, for example, in the above-described embodiments, the explanation has been given such that the parts are classified into the hardware parts and the software parts. Concerning the present invention, however, the hardware parts are not limited to what exists as parts physically. For example, even “Register Transfer Level (RTL)” design data where logic is described using hardware description language, and logic design data described using C language can be addressed similarly.

Also, in the above-described embodiments, the explanation has been given regarding the function of the extraction unit 180 (or extraction unit 360) by selecting, as its example, the case where the function is implemented such that the CPU 10 executes each program (OS and extraction programs). The present invention, however, is not particularly limited thereto. The function of the extraction unit 180 (or extraction unit 360) may also be implemented using, e.g., specific hardware (i.e., ASIC (Application Specific Integrated Circuit) or the like) which is specifically designed for implementing the function of the extraction unit 180 (or extraction unit 360).

It should be further understood by those skilled in the art that although the foregoing description has been made on embodiments of the invention, the invention is not limited thereto and various changes and modifications may be made without departing from the spirit of the invention and the scope of the appended claims.

1. A computer development apparatus for holding design resource information and extracting, out of said design resource information, design data for implementing specified functions of a computer, said design resource information being a collection of computer design data, wherein
said design resource information comprises a hardware-parts database and a software-parts database, said hardware-parts database being a database for registering design data on hardware parts in a manner of being caused to correspond to each other for each of hardware-parts identification data for identifying said hardware parts, said software-parts database being a database for registering design data on software parts in a manner of being caused to correspond to each other for each of software-parts identification data for identifying said software parts,
said computer development apparatus, comprising:
a relation database for registering data for identifying a hardware part and a software part for each function of a computer, said hardware part and said software part being necessary for implementing each function,
a constraint condition database for registering a constraint condition, said constraint condition including information for specifying functions of a development-target computer, and
extraction means for
identifying a hardware part and a software part for each function included in said constraint condition by using said constraint condition database and said relation database, said hardware part and said software part being necessary for implementing each function included in said constraint condition,
extracting, out of said design resource information, design data corresponding to said identified hardware part and software part, and
outputting said extracted design data.

2. The computer development apparatus according to claim 1, wherein
said design resource information further comprises a test-parts database, test design data used for tests for checking functions of a computer being registered in said test-parts database for each of test identification data for identifying said tests,
said data for identifying said test for checking each function of said computer being further related with said data registered in said relation database, in addition to said data for identifying said hardware part and said software part for each function of said computer, said hardware part and said software part being necessary for implementing each function,
said extraction means identifying said test for checking each function included in said constraint condition by using said constraint condition database and said relation database, extracting, out of said design resource information, test design data corresponding to said identified test, and outputting said extracted test design data in a manner of being included in said design data.

3. The computer development apparatus according to claim 2, wherein
said design data included in said design resource information comprises plural types of information,
in said constraint condition, each output flag for specifying whether or not said information of each of said plural types should be outputted for each of said plural types of said design data being caused to correspond to said information for specifying each function of said computer,
said extraction means, when extracting said design data, making reference to each output flag, and extracting and outputting only design data of a type which is caused to correspond to an output flag for specifying that said design data of said type should be outputted.

4. The computer development apparatus according to claim 1, wherein
said design data included in said design resource information comprises plural types of information,
in said constraint condition, each output flag for specifying whether or not said information of each of said plural types should be outputted for each of said plural types of said design data being caused to correspond to said information for specifying each function of said computer,
said extraction means, when extracting said design data, making reference to each output flag, and extracting and outputting only design data of a type which is caused to correspond to an output flag for specifying that said design data of said type should be outputted.

5. The computer development apparatus according to claim 4, wherein
a management record is caused to correspond to each of said identifying data registered in said relation database,
said management record being caused to correspond to each of said hardware-parts identification data, and said software-parts identification data included in said design resource information,
said extraction means outputting a warning message if, in said design resource information to be outputted, there exists none of design data whose management record is the same as said management record caused to correspond to said relation database.

6. The computer development apparatus according to claim 2, wherein
a management record is caused to correspond to each of said identifying data registered in said relation database,
said management record being caused to correspond to each of said hardware-parts identification data, said software-parts identification data, and said test identification data included in said design resource information,
said extraction means outputting a warning message if, in said design resource information to be outputted, there exists none of design data whose management record is the same as said management record caused to correspond to said relation database.

7. The computer development apparatus according to claim 3, wherein
a management record is caused to correspond to each of said identifying data registered in said relation database,
said management record being caused to correspond to each of said hardware-parts identification data, said software-parts identification data, and said test identification data included in said design resource information,
said extraction means outputting a warning message if, in said design resource information to be outputted, there exists none of design data whose management record is the same as said management record caused to correspond to said relation database.

8. The computer development apparatus according to claim 7, further comprising:
configuration means for receiving configuration of said constraint condition specified by an operation from user.

9. The computer development apparatus according to claim 8, wherein
said computer development apparatus is connected to a terminal apparatus via a network,
said configuration means comprising communications means for performing transmission/reception of data via said terminal apparatus and said network,
said communications means performing a processing of outputting said constraint condition registered at present in accordance with a data reference request from said terminal apparatus, and performing a processing of receiving modification of said constraint condition registered at present in accordance with a data configuration request from said terminal apparatus.

10. The computer development apparatus according to claim 9, wherein,
in said hardware-parts database, sharing information for indicating whether or not said hardware parts identified by said hardware-parts identification data are sharing-enabled parts is caused to correspond to said hardware-parts identification data for each of hardware-parts identification data,
said extraction means, if a plurality of identical hardware parts exist within said identified hardware parts,
judging whether or not said identical hardware parts are sharing-enabled parts by using said sharing information in said hardware-parts database, and
extracting, out of said design resource information, said design data after said identical hardware parts which are judged to be sharing-enabled are reduced into a single hardware part in number.

11. The computer development apparatus according to claim 1, wherein,
in said hardware-parts database, sharing information for indicating whether or not said hardware parts identified by said hardware-parts identification data are sharing-enabled parts is caused to correspond to said hardware-parts identification data for each of hardware-parts identification data,
said extraction means, if a plurality of identical hardware parts exist within said identified hardware parts,
judging whether or not said identical hardware parts are sharing-enabled parts by using said sharing information in said hardware-parts database, and
extracting, out of said design resource information, said design data after said identical hardware parts which are judged to be sharing-enabled are reduced into a single hardware part in number.

12. The computer development apparatus according to claim 2, wherein,
in said hardware-parts database, sharing information for indicating whether or not said hardware parts identified by said hardware-parts identification data are sharing-enabled parts is caused to correspond to said hardware-parts identification data for each of hardware-parts identification data,
said extraction means, if a plurality of identical hardware parts exist within said identified hardware parts,
judging whether or not said identical hardware parts are sharing-enabled parts by using said sharing information in said hardware-parts database, and
extracting, out of said design resource information, said design data after said identical hardware parts which are judged to be sharing-enabled are reduced into a single hardware part in number.

13. The computer development apparatus according to claim 3, wherein,
in said hardware-parts database, sharing information for indicating whether or not said hardware parts identified by said hardware-parts identification data are sharing-enabled parts is caused to correspond to said hardware-parts identification data for each of hardware-parts identification data,
said extraction means, if a plurality of identical hardware parts exist within said identified hardware parts,
judging whether or not said identical hardware parts are sharing-enabled parts by using said sharing information in said hardware-parts database, and
extracting, out of said design resource information, said design data after said identical hardware parts which are judged to be sharing-enabled are reduced into a single hardware part in number.

14. The computer development apparatus according to claim 4, wherein,
in said hardware-parts database, sharing information for indicating whether or not said hardware parts identified by said hardware-parts identification data are sharing-enabled parts is caused to correspond to said hardware-parts identification data for each of hardware-parts identification data,
said extraction means, if a plurality of identical hardware parts exist within said identified hardware parts,
judging whether or not said identical hardware parts are sharing-enabled parts by using said sharing information in said hardware-parts database, and
extracting, out of said design resource information, said design data after said identical hardware parts which are judged to be sharing-enabled are reduced into a single hardware part in number.

15. The computer development apparatus according to claim 14, wherein,
if a plurality of identical software parts exist within said identified software parts,
said extraction means extracts, out of said design resource information, said design data after said identical software parts are reduced into a single software part in number.

16. The computer development apparatus according to claim 10, wherein,
if a plurality of identical software parts exist within said identified software parts,
said extraction means extracts, out of said design resource information, said design data after said identical software parts are reduced into a single software part in number.

17. The computer development apparatus according to claim 12, wherein,
if a plurality of identical software parts exist within said identified software parts,
said extraction means extracts, out of said design resource information, said design data after said identical software parts are reduced into a single software part in number.

18. The computer development apparatus according to claim 11, wherein,
if a plurality of identical software parts exist within said identified software parts,
said extraction means extracts, out of said design resource information, said design data after said identical software parts are reduced into a single software part in number.

19. The computer development apparatus according to claim 13, wherein,
if a plurality of identical software parts exist within said identified software parts,
said extraction means extracts, out of said design resource information, said design data after said identical software parts are reduced into a single software part in number.
